(19) United States
(12) Patent Application Publication
(10) Pub. No.: US 2026/0147301 A1
(43) Pub. Date: May 28, 2026

(54) IMAGE DIAGNOSTIC METHOD, IMAGE DIAGNOSTIC DEVICE, AND IMAGE FORMING APPARATUS

(71) Applicant: Konica Minolta, Inc., Tokyo (JP)

(72) Inventors: Pushkarkumar KHATRI, Tokyo (JP); Hokuto HATANO, Tokyo (JP); Daisuke GENDA, Kawasaki-shi (JP)

(21) Appl. No.: 19/396,432

(22) Filed: Nov. 21, 2025

(30) Foreign Application Priority Data
Nov. 27, 2024 (JP) 2024-205977

(51) Int. Cl. G03G 15/00

(52) U.S. Cl. CPC G03G 15/5062; G03G 15/55; G03G 15/6561; G03G 15/6567; G03G 2215/00405; G03G 2215/00561; G03G 2215/00772; G03G 2215/00776

(57) ABSTRACT

An image diagnostic method is executed by an image diagnostic device for an image formed by an image forming apparatus including: an image forming engine; and a reader that reads a medium. The image diagnostic method includes: adjusting an image formation position; and, after the adjusting, diagnosing a state of the image forming engine. The adjusting includes: causing the image forming engine to form a first pattern on a first medium for adjusting the image formation position; causing the reader to read the first medium; and adjusting the image formation position based on the reading result. The diagnosing includes: causing the image forming engine to form a second pattern on a second medium for diagnosing the state of the image forming engine; causing the reader to read the second medium; and acquiring a diagnosis result of the state of the image forming engine based on the reading result.

### CROSS-REFERENCE TO RELATED APPLICATIONS

The entire disclosure of Japanese Patent Application No. 2024-205977 filed on November 27, 2024, is incorporated herein by reference in its entirety.

### BACKGROUND OF THE INVENTION

### TECHNICAL FIELD

The present invention relates to an image diagnostic method, an image diagnostic device, and an image forming apparatus.

### DESCRIPTION OF RELATED ART

There is a technique in which a predetermined test image formed on a medium in an image forming apparatus is read by a reading section located on a conveyance route of the medium, and the read image is analyzed. Image diagnosis for diagnosing the state of an image forming engine can be performed based on the results of the analysis.

In the analysis of the read image, image defects such as streaks and noise appearing in the image are detected. The streaks include a streak extending in a conveyance direction (feed direction) and a streak extending in a direction perpendicular to the conveyance direction (cross direction). The noise includes spotty noise that appears periodically. In addition to the presence or absence of these occurrences, information such as the location and frequency of occurrences can be acquired from test images formed on different media of the same type to accurately obtain the state of the image forming engine (e.g., JP 2019-133020A).

### SUMMARY OF THE INVENTION

However, with improvement in image quality and productivity, in recent years, there has been a problem that the state of the image forming engine cannot be obtained with required accuracy by the conventional image diagnostic technology.

An object of the present invention is to provide an image diagnostic method, an image diagnostic device, and an image forming apparatus capable of performing image diagnosis with higher accuracy.

To achieve at least one of the abovementioned objects, an image diagnostic method reflecting one aspect of the present invention is an image diagnostic method executed by an image diagnostic device for an image formed by an image forming apparatus including: an image forming engine; and a reader that is disposed along a conveyance path of a medium and reads the medium downstream of an image formation site of the image forming engine on the conveyance path, the image diagnostic method comprising: adjusting an image formation position; and, after the adjusting, diagnosing a state of the image forming engine, wherein the adjusting includes: causing the image forming engine to form a first pattern for adjusting the image formation position; causing the reader to read a first medium on which the first pattern has been formed; and adjusting the image formation position based on a reading result of the first medium, and the diagnosing includes: causing the image forming engine to form a second pattern for diagnosing the state of the image forming engine; causing the reader to read a second medium on which the second pattern has been formed; and acquiring a diagnosis result of the state of the image forming engine based on a reading result of the second medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front schematic diagram illustrating a configuration of an image forming apparatus;

FIG. 2 is a diagram illustrating functional blocks of the image forming apparatus;

FIG. 3 is a diagram illustrating a procedure of image diagnosis;

FIG. 4A is a diagram illustrating an example of a first test image for image position adjustment;

FIG. 4B is a diagram illustrating an example of the first test image for image position adjustment;

FIG. 5A is a diagram illustrating an example of a read image of a medium when there is a misalignment in a formed image;

FIG. 5B is a diagram illustrating an example of a read image of a medium when there is a misalignment in a formed image;

FIG. 6A is a diagram illustrating an example of a read image of a medium when there is a misalignment in a formed image;

FIG. 6B is a diagram illustrating an example of a read image of a medium when there is a misalignment in a formed image;

FIG. 7 is a diagram illustrating an example of a read image of a medium when there is a misalignment in a formed image;

FIG. 8 is a flowchart illustrating a control procedure of a position adjustment control process;

FIG. 9 is a flowchart illustrating a control procedure of an image diagnosis control process;

FIG. 10 is a diagram illustrating an example of a second test image for simple image diagnosis;

FIG. 11 is a flowchart illustrating a control procedure of a streak and spot detection process;

FIG. 12 is a flowchart illustrating a control procedure of a FD streak detection process;

FIG. 13 is a flowchart illustrating a control procedure of a spot detection process;

FIG. 14 is a flowchart illustrating a control procedure of a CD streak detection process;

FIG. 15 is a flowchart illustrating a control procedure of a detailed image diagnosis process;

FIG. 16 is a flowchart illustrating a control procedure of a FD streak detailed analysis process;

FIG. 17 is a flowchart illustrating a control procedure of the FD streak detailed analysis process;

FIG. 18 is a flowchart illustrating a control procedure of a spot detailed analysis process;

FIG. 19 is a flowchart illustrating a control procedure of a spot type diagnosis process;

FIG. 20 is a flowchart illustrating a control procedure of the spot type diagnosis process;

FIG. 21 is a flowchart illustrating a control procedure of a primary transfer output adjustment process;

FIG. 22 is a flowchart illustrating a control procedure of a secondary transfer output adjustment process;

FIG. 23 is a flowchart illustrating a control procedure of a developing AC bias output adjustment process;

FIG. 24 is a flowchart illustrating a control procedure of a CD streak detailed analysis process;

FIG. 25A is a diagram illustrating an example of an initial setting screen for image adjustment;

FIG. 25B is a diagram illustrating an example of the initial setting screen for image adjustment;

FIG. 26 is a diagram illustrating a procedure of image diagnosis according to another embodiment;

FIG. 27 is a diagram illustrating an example of a screen displayed while image diagnosis is in progress;

FIG. 28A is a diagram illustrating an example of a result display screen displayed after the image diagnosis has been executed; and

FIG. 28B is a diagram illustrating an example of the result display screen displayed after the image diagnosis has been executed.

### DETAILED DESCRIPTION

Hereinafter, one or more embodiments of the present invention will be described with reference to the drawings. However, the scope of the invention is not limited to the disclosed embodiments.

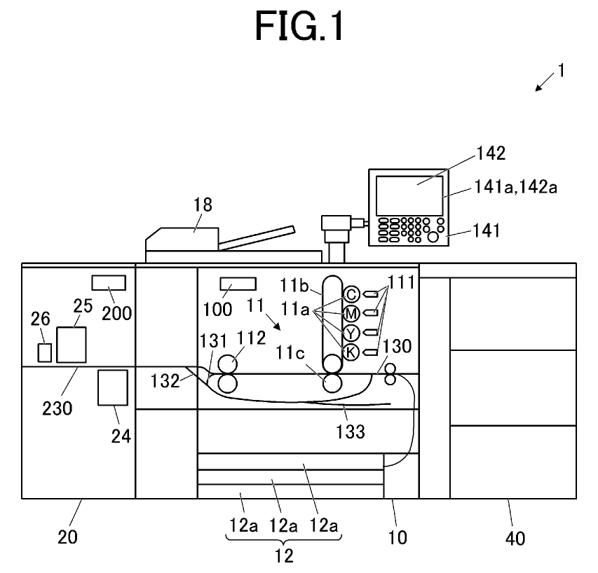

FIG. 1 is a front schematic diagram illustrating a configuration of an image forming apparatus 1.

The image forming apparatus 1 includes an apparatus body 10 that performs image formation. The image forming apparatus 1 may include a sheet feed device 40 on a preceding stage side of the apparatus body 10, and a reading device (reader) 20 on a subsequent stage side of the apparatus body 10. Each device and the apparatus body 10 are electrically and mechanically connected to each other, and sheet conveyance and communication can be performed between each device and the apparatus body 10.

The sheet feed device 40 includes a plurality of sheet feed stages for storing a medium on which an image is to be formed. The sheet feed device 40 is capable of supplying a medium stored in the plurality of sheet feed stages to the apparatus body 10 at a subsequent stage. The medium may not be paper. For example, the medium may be cloth, plastic, or the like.

The apparatus body 10 includes an image forming operation section (image forming engine) 11, a main body sheet feed section 12, a conveyance path 130, a reverse conveyance path 131, a downstream conveyance path 132, a retreat conveyance path 133, an automatic document feeder 18, a controller (hardware processor) 100, an operation reception section 141, and a display part 142.

The main body sheet feed section 12 is disposed in a lower portion of the housing of the apparatus body 10. The main body sheet feed section 12 includes a plurality of feeding trays 12a for a plurality of media. Each of the plurality of feeding trays 12a stores a medium and can send out the medium one by one. The material of the medium may not be paper. For example, the medium may be cloth or plastic. Replenishment of the feeding tray 12a with the medium may be manually performed by a user or the like. During the image forming operation, when the feeding tray 12a that stores the medium to be subjected to image formation becomes empty, a notification operation may be performed by the display part 142 or the like to indicate that the medium needs to be supplied. Note that the shape of the feeding trays referred to herein is not limited to a normal tray-like shape as long as the feeding trays can store a plurality of media and supply the media one by one to the apparatus body 10.

The conveyance path 130 extends inside the housing of the apparatus body 10. The medium fed from the sheet feed device 40 or the main body sheet feed section 12 is conveyed along the conveyance path 130 by guide rollers or the like.

The image forming operation section 11 is an image forming engine that performs an operation of forming an image based on image data. The image forming operation section 11 is disposed in contact with the middle of the conveyance path 130. The image forming operation section 11 includes photoreceptors 11a for respective colors of cyan, magenta, yellow, and black (CMYK). Corresponding to each of the photoreceptors 11a, a charging device, a laser diode, a developing device, a cleaning section, and the like (not illustrated) are disposed around the photoreceptor 11a. In addition, the image forming operation section 11 includes an intermediate transfer belt 11b that circularly moves to a position in contact with each photoreceptor 11a. The intermediate transfer belt 11b contacts the medium on the conveyance path 130 at a secondary transfer section 11c in the middle. Furthermore, a fixing section 112 is disposed downstream of the secondary transfer section 11c in a medium conveyance direction of the conveyance path 130.

When an image is formed on the medium, after the photoreceptor 11a is uniformly charged by the charging device, laser light is emitted from a laser diode 111 to the photoreceptor 11a according to the image, and a latent image is formed on the photoreceptor 11a. The latent image on the photoreceptor 11a is developed into a toner image by the developing device. The toner image on the photoreceptor 11a is primarily transferred to the intermediate transfer belt 11b. The image on the intermediate transfer belt 11b is secondarily transferred to the medium at the secondary transfer section 11c. The medium on which the image is formed is conveyed downstream along the conveyance path 130, and the image is fixed by the fixing section 112.

The reverse conveyance path 131 branches off from the conveyance path 130 downstream of the fixing section 112. In the middle of the reverse conveyance path 131, the downstream conveyance path 132 branches off and is connected to the conveyance path 130 downstream of the branching position of the reverse conveyance path 131. The retreat conveyance path 133 branches off from the reverse conveyance path 131 downstream of the branching position of the downstream conveyance path 132. The downstream end of the reverse conveyance path 131 merges with the conveyance path 130 at a position upstream of the image forming operation section 11. The conveyance path 130 is connected to a conveyance path 230 of the reading device 20 connected to a subsequent stage of the apparatus body 10.

When image formation is performed only on one surface of the medium, the medium on which the image formation has been performed is conveyed along the conveyance path 130 and is sent out to the conveyance path 230 of the reading device 20 as it is. When the front and back surfaces of the medium are to be switched for output after image formation on one surface, the medium is first sent from the conveyance path 130 to the reverse conveyance path 131. After the medium is conveyed through the reverse conveyance path 131 beyond the branching position of the downstream conveyance path 132, the medium is reversely conveyed through the reverse conveyance path 131 and sent to the downstream of the conveyance path 130 via the downstream conveyance path 132. When an image is to be formed on the back surface of the medium by reversing the medium after image formation on the front surface, the medium is sent from the conveyance path 130 to the reverse conveyance path 131. Then, after the medium is sent from the reverse conveyance path 131 to the retreat conveyance path 133, the medium is sent, with changing the front and rear of the medium, to the downstream of the reverse conveyance path 131, and is circulated to the conveyance path 130. Thereafter, image formation on the back surface of the medium is performed at the image forming operation section 11.

The display part 142 includes a display screen 142a. The display screen 142a may be, for example, a liquid crystal display (LCD). The display part 142 can display information on the display screen 142a under the control of the controller 100. The display part 142 may be capable of changing the position and orientation of the display screen 142a.

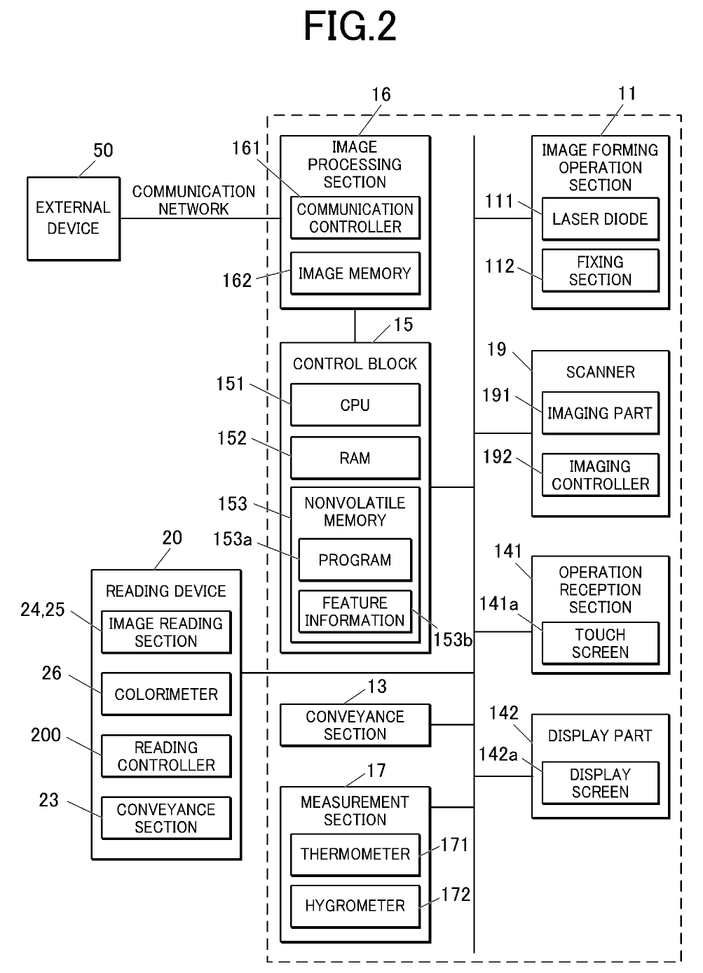

The operation reception section 141 includes a touch screen 141a (see FIG. 2) disposed so as to overlap the display screen 142a described above, and an operation key group such as a numeric keypad. The operation reception section 141 receives an input operation to the touch screen 141a and the operation key group and outputs the content of the input operation as an operation signal to the controller 100. Note that the operation reception section 141 and the display part 142 need not be integrated with each other. For example, the operation reception section 141 may include a pointing device such as a mouse. Alternatively, the operation reception section 141 may be a tablet, a portable terminal, or the like separate from the display part 142 and may be capable of transmitting an operation signal to the controller 100 via wireless communication.

The automatic document feeder 18 (ADF) may be disposed on top of the housing of the apparatus body 10 at a position different from the operation reception section 141. The automatic document feeder 18 automatically feeds a document set on a document placement table so that a scanner 19 (see FIG. 2) can read the document.

The controller 100 controls the overall operation of the image forming apparatus 1. The controller 100 includes a central processing unit (CPU) and a memory. A single CPU may be provided, or a plurality of CPUs may be provided so that arithmetic operations can be performed in parallel. The memory includes a volatile memory (RAM) and a nonvolatile memory. The RAM provides a working memory space for the CPU and stores temporary data. The nonvolatile memory stores programs, setting data, and the like. The non-volatile memory may include some or all of a hard disk drive (HDD), a flash memory, and the like. The flash memory may be a solid state drive (SSD).

The reading device 20 includes the conveyance path 230, image reading sections 24 and 25, a colorimeter 26, a reading controller (hardware processor) 200, and the like. The conveyance path 230 is connected to the conveyance path 130 of the apparatus body 10. The medium sent out from the conveyance path 130 is conveyed to the conveyance path 230. Downstream of the conveyance path 230, the medium may be ejected as it is. Alternatively, the medium may be sent to a medium ejection device (sheet ejection device) or the like (not illustrated).

The image reading section 24 reads the bottom surface of the conveyed medium in the middle of the conveyance path 230, that is, downstream of the image formation site. The image reading section 25 reads the top surface of the conveyed medium in the middle of the conveyance path 230. The image reading section 24 may be disposed upstream of the image reading section 25 in the conveyance direction along the conveyance path 230. The colorimeter 26 performs color measurement on the image on the top surface of the medium downstream of the image reading section 25 in the conveyance direction.

Each of the image reading sections 24 and 25 may include an imaging sensor such as a CCD sensor or a CMOS sensor. The image sensor may be a line sensor. The line sensor is capable of imaging across the entire width of the medium in a direction intersecting the conveyance direction of the medium. Thus, the image reading sections 24 and 25 can read the entire surface of the conveyed medium. The reading results read by the image reading sections 24 and 25 and the colorimeter 26 are transmitted to the reading controller 200. Each of the image reading sections 24 and 25 may include a white plate and a black plate that can be switched to the background position of the medium in the imaging range.

The reading controller 200 includes a CPU, a memory, and the like and controls the operation of the reading device 20. The CPU may include a single hardware processor or may include a plurality of hardware processors. The plurality of hardware processors may perform arithmetic processing independently of each other or in parallel. The memory includes a RAM and a nonvolatile memory. The RAM provides a working memory space for the CPU and stores temporary data. The nonvolatile memory stores programs, setting data, and the like. The nonvolatile memory may include at least one of an HDD or a nonvolatile memory.

In the above description, the two image reading sections 24 and 25 read the top and bottom surfaces of the medium, but a single image reading section may read the top and bottom surfaces of the medium. In this case, the reading device 20 may include a reverse conveyance path connected to the conveyance path 230 and perform reverse conveyance of the medium so that the image reading section can sequentially read both surfaces of the medium.

Note that in the present embodiment, a CPU 151 diagnoses an image based on a read image read by the reading device 20. Therefore, the read image read by the image reading sections 24 and 25 is transferred to the CPU 151 from the reading controller 200. In another embodiment, the reading controller 200 may perform image diagnosis based on the read image. In this case, the reading controller 200 is included in an image diagnostic device.

The reading controller 200 can output an instruction to perform image adjustment, machine adjustment, or the like to the CPU 151 as necessary.

The image forming apparatus 1 may include other components in addition to the apparatus body 10, the reading device 20, and the sheet feed device 40. Alternatively, as described above, as long as the image forming apparatus 1 includes at least the apparatus body 10, the reading device 20 and the sheet feed device 40 may be disposed outside the image forming apparatus 1.

FIG. 2 is a diagram illustrating functional blocks of the image forming apparatus 1.

The image forming apparatus 1 includes a control block 15, the image forming operation section 11, a conveyance section 13, the scanner 19, the operation reception section 141, the display part 142, an image processing section 16, a measurement section 17, and the reading device 20. The apparatus body 10 may include all of the control block 15, the image forming operation section 11, the conveyance section 13, the scanner 19, the operation reception section 141, the display part 142, the image processing section 16, and the measurement section 17. Alternatively, the reading device 20 may include some of the above-described components.

The image processing section 16 performs processing on acquired image data. The image processing section 16 may be capable of converting image data that is acquired from an external device 50 via a communication controller 161 or input from the scanner 19 into a format with which an image can be formed by the image forming operation section 11. Furthermore, the image processing section 16 may be capable of appropriately processing image data acquired from the scanner 19 and outputting the image data to the external device 50 via the communication controller 161. The image data before and after the processing can be stored in an image memory 162. The image memory 162 may be a DRAM. Reference image data for image diagnosis and the like may be stored in the image memory 162. The communication controller 161 includes a network interface card (NIC) that controls communication via a network such as a local area network (LAN). The network is not limited to the LAN. The network is not limited to a wired network or a wireless network.

The control block 15 includes the CPU 151 (controller, hardware processor), a RAM 152, and a nonvolatile memory 153. The control block 15 controls the overall operation of the image forming apparatus 1. For example, the CPU 151 of the control block 15 can perform conveyance control of a medium, control of an image forming operation, processing control of image data, diagnosis of an image formed on a medium, and the like. The processing control of image data may include adjustment processing of an image for image formation obtained by the image processing section 16. The CPU 151 is included in an image diagnostic device according to the present embodiment. Each configuration of the control block 15 may be the same as each configuration of the controller 100. The nonvolatile memory 153 stores a program 153a, setting information of each component, setting parameters related to an image forming operation, and the like. The program 153a includes a control program for image diagnosis. The setting information includes feature information 153b. The feature information 153b includes a feature and a cause of a streak, a spot, or the like to be detected. Note that the image data, job data acquired from the outside, the setting parameters, parameters of image diagnosis and test images for diagnosis, results of image diagnosis, and the like may be stored in an external memory outside the control block 15 as necessary. The control block 15 can count the current date and time, the elapsed time, and the like based on a clock signal related to the operation.

The image forming operation section 11 forms latent images on the photoreceptors 11a in accordance with the light emission patterns of the laser diodes 111 as described above, develops the latent images with toner, and then transfers the toner onto a medium via the intermediate transfer belt 11b. The fixing section 112 fixes the toner on the medium, thereby forming an image. The light emission patterns of the laser diodes 111 are determined according to image data for image formation processed by the image processing section 16 and stored in the image memory 162.

The conveyance section 13 includes a rotary roller, a rotary motor that rotates the rotary roller, and the like. The conveyance section 13 switches the connections between the conveyance path 130, the reverse conveyance path 131, the downstream conveyance path 132, and the retreat conveyance path 133 to convey the medium through an appropriate path at an appropriate speed.

The scanner 19 captures an image of a reading surface of a document fed to a reading position by the automatic document feeder 18 and generates image data of the reading surface. The scanner 19 includes an imaging part 191 and an imaging controller 192. The imaging part 191 may be a line sensor such as a CCD sensor or a CMOS sensor. The imaging part 191 scans the reading surface under the control of the imaging controller 192, that is, moves relative to the reading surface, so that image data of the entire reading surface is obtained. The read image data is formatted into a predetermined format by the imaging controller 192 and then sent to the image processing section 16 via serial communication or the like. The imaging controller 192 includes a CPU and a memory. As the CPU and the memory of the imaging controller 192, the CPU and the memory of the controller 100 of the apparatus body 10 may be used, or a hardware configuration separate from the CPU and the memory of the controller 100 may be adopted.

The operation reception section 141 includes operation devices such as the touch screen 141a and the operation key group as described above and outputs an operation signal in response to a received input operation. The operation devices allow setting of image formation conditions in the image forming apparatus 1 and input of operation control conditions such as operation commands. The display part 142 includes the display screen 142a as described above and performs display under the control of the controller 100 or the CPU 151. On the display screen 142a, setting contents of the image formation conditions, a setting change reception screen, the progress and the status of an image forming operation, and the like can be displayed.

The measurement section 17 measures environmental conditions at a predetermined location in the apparatus body 10, for example, in the vicinity of a conveyance position of the medium in the image forming operation section 11. The measurement section 17 may include, for example, a thermometer 171 and a hygrometer 172. The thermometer 171 measures temperature, and the hygrometer 172 measures humidity. The measurement result is converted into a digital value with appropriate sampling accuracy to be output to the CPU 151 of the control block 15. In addition to or instead of the above, the thermometer 171 and hygrometer 172 may measure the temperature and humidity outside the apparatus body 10, i.e., the ambient temperature and humidity, respectively.

The reading device 20 includes a conveyance section 23 in addition to the above-described image reading sections 24 and 25, the colorimeter 26, and the reading controller 200. The reading controller 200 can perform imaging control of the image reading sections 24 and 25, generation of a read image based on an imaging result, output of the generated read image data, and the like. Here, the reading device 20 is connected to a bus of the apparatus body 10 but may be connected via an appropriate connection terminal or communication controller. Further, the read image data may be directly input to the image forming operation section 11 or the control block 15. The conveyance section 23 conveys the medium sent out from the conveyance path 130 of the apparatus body 10 along the conveyance path 230. The conveyance section 23 includes a rotary roller along the conveyance path 230 and a rotary motor that rotates the rotary roller. As described above, when the front and back surfaces of the media can be reversed on the conveyance path 230, the conveyance section 23 can switch the conveyance route depending on whether reversal is required. The setting of the conveyance speed and the switching of the conveyance route may be performed based on a control signal received from the control block 15 of the apparatus body 10 or the like.

Thus, the image forming apparatus 1 can perform the following three processes regarding images. (1) Process of processing image data acquired from the outside to form an image. (2) Copying process of processing image data of an image read by the scanner 19 to form an image. (3) Scanning process of outputting an image read by the scanner 19 to the outside as image data.

Parameter settings related to image formation may be acquired not only by an input operation via the operation reception section 141 but also by a setting operation performed at the external device 50 via a printer driver. The setting contents at the external device 50 may be acquired from the external device 50 via the communication controller 161.

Next, image diagnosis will be described. As described above, the CPU 151 can perform image diagnosis based on the read image of the medium obtained by the reading device 20. In the image diagnosis, it is possible to perform simple diagnosis of image quality by using read data of a simple image diagnosis pattern (second pattern) formed on the medium (second medium). In the diagnosis of the image quality, it may be possible to diagnose, for example, surface image quality such as gradation, maximum density, edge quality of a patch portion, development memory, and graininess, as well as line image quality such as line width and color shift. The contents of the diagnosis are not limited thereto, and any suitable items may be added. In addition, in the image diagnosis, it is possible to perform diagnosis related to image noise using an image noise diagnostic pattern printed on a medium. Examples of the image noise include a streak, banding, a spot, and dirt. The streak and the banding are noises that extend remarkably in a certain direction. The spot is noise that exists in isolation in a two-dimensional plane. Examples of the spot include a white spot of white, a black spot of black, colored spots of other colors, and a firefly. The white spot is a void, where no toner is applied where toner is to be applied. The black spot is caused by localized solidification of toner. Circular two-dimensional density unevenness due to a transfer error or the like is called a firefly. Here, spots and fireflies are collectively referred to as spots. The dirt is noise that attaches even when image formation is not performed. The dirt may be irregularly shaped and spread out.

As a prerequisite for this image diagnosis, an image formation position can be adjusted in the image forming apparatus 1. When there is misregistration in a test image for diagnosis during image diagnosis, the accuracy of diagnosis decreases. Therefore, in one embodiment, before the test image for diagnosis is formed, adjustment of the image formation position, in particular, front-to-back register adjustment for aligning the image formation position and orientation between the front and back surfaces is performed.

The image diagnosis including the adjustment of the image formation position may be periodically performed. For example, the image diagnosis may be performed every predetermined time of about 1 to 3 days, every number of sheets in continuous image formation, at the start of daily power supply when power supply to the image forming apparatus 1 is cut off every night, or the like. In addition, when the medium stored in the tray is changed, when a temperature condition and/or a humidity condition of the image forming apparatus 1 is largely changed, when the roller rotation speed, the nip pressure, or the like of the conveyance sections 13 and 23 is changed by a predetermined reference value or more, or the like, the image diagnosis may be performed at any time, at a break in an image forming operation, or the like.

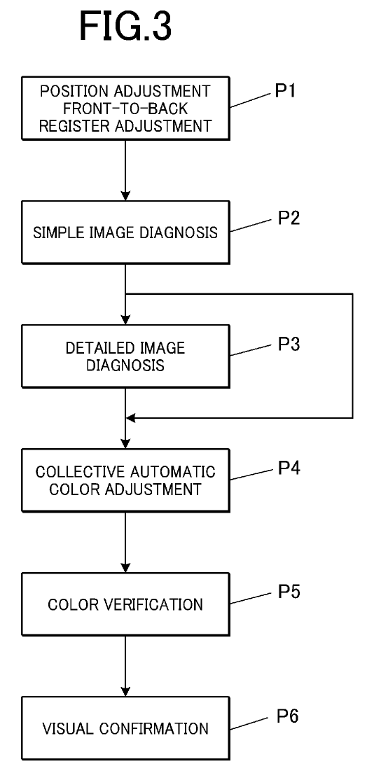

FIG. 3 is a diagram illustrating a procedure of the image diagnosis.

In an image diagnostic method according to the present embodiment, first, alignment of each surface of the medium and front-to-back register adjustment are performed (P1; adjustment step). A simple diagnosis of an image is performed (P2), and when a problem is detected in the simple diagnosis, a detailed diagnosis of the image is performed (P3). Steps P2 and P3 are included in a diagnosis step in the present embodiment.

Respective CMYK colors are automatically adjusted at once (P4), and color verification is performed (P5). Finally, the image and the color are visually confirmed by a user (P6). If there is no problem, the image diagnosis ends. Any conventionally known processing can be applied to the steps (P4 to P6) after the position adjustment and the image diagnosis, and a detailed description thereof is omitted.

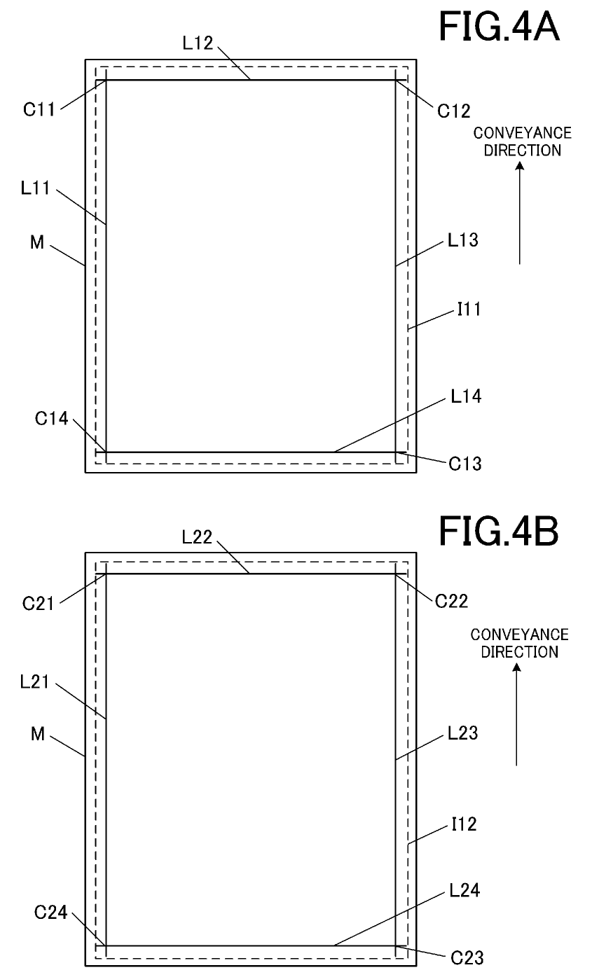

FIGS. 4A and 4B are diagrams illustrating examples of a first test image I1 for the image position adjustment. FIG. 4A illustrates a test image I11 formed on the front surface of the medium, and FIG. 4B illustrates a test image I12 formed on the back surface of the medium. The position of the formed first test image (first pattern) is identified by the test images I11 and I12 for the front and back surfaces of the medium M, respectively. The pattern of the test image I11 and the pattern of the test image I12 may be identical. The test image I11 includes four lines L11 to L14 along the four sides of the medium M. The test image I12 includes four lines L21 to L24 along the four sides of the medium M. When the images are formed in the normal position, the coordinates of the intersections C11 to C14 of the four lines L11 to L14 and the coordinates of the intersections C21 to C24 of the four lines L21 to L24 appear correctly. In addition, a set of lines L11 and L13 and a set of lines L21 and L23 along the conveyance direction are parallel to each other, and the lines L12 and L14 are parallel to each other and perpendicular to the lines L11 and L13. The first test image I1 may be formed in a single color, for example, black.

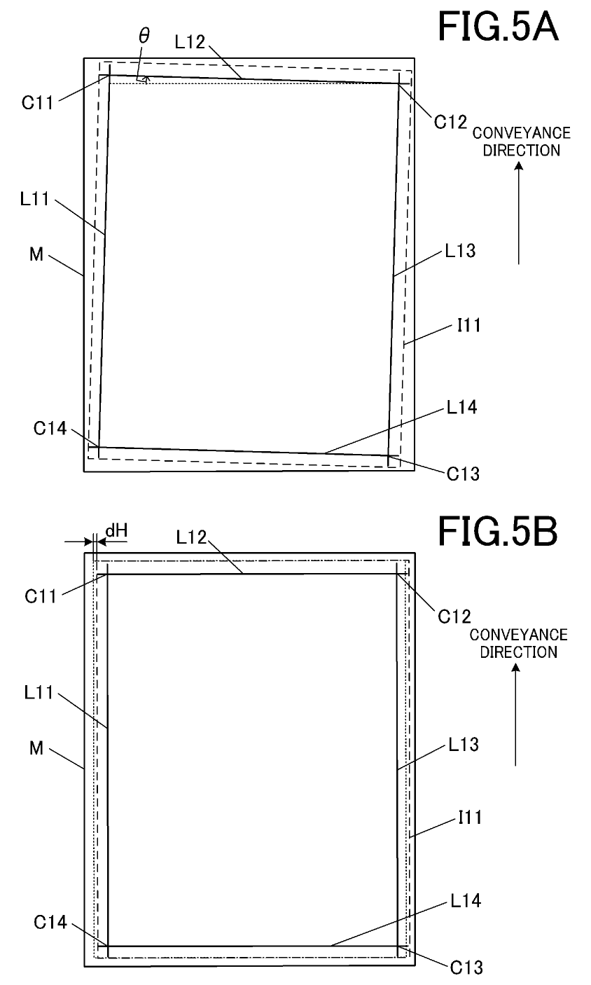

FIGS. 5A to 7 are diagrams illustrating examples of a read image of the medium M when there is a misalignment in a formed image.

As illustrated in FIG. 5A, when the position of the formed image (image formation position) is shifted by a rotation angle θ, the read image of the medium (first medium) on which the first test image I1 is formed is also shifted by the same angle. As illustrated in FIG. 5B, when the image formation position is shifted in a direction perpendicular to the conveyance direction, the read image is also shifted by a width dH in a width direction perpendicular to the conveyance direction. The magnitude of the misregistration may be obtained by a difference between the coordinates of the intersections C11 to C14 and C21 to C24 in these read images and the coordinates in a read image of the reference image that are expected when the image is simply formed normally. Alternatively, the magnitude of the misregistration and the enlargement/reduction ratio may be determined based on the relative position with respect to a corner position or the like of the medium M in each image. Furthermore, in the misregistration illustrated in FIGS. 5A and 5B, the misregistration is symmetrical between front and the back surfaces. Therefore, the average position of the image formation positions on the front and back surfaces is to be the correct image formation position. Based on the misregistration amount from the average position, the misregistration amount of the image formation position may be identified.

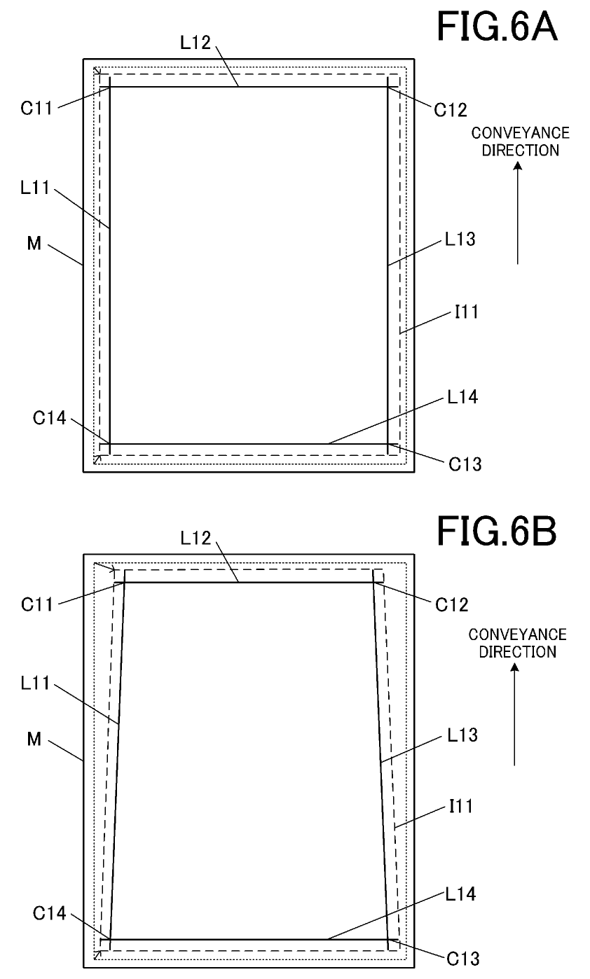

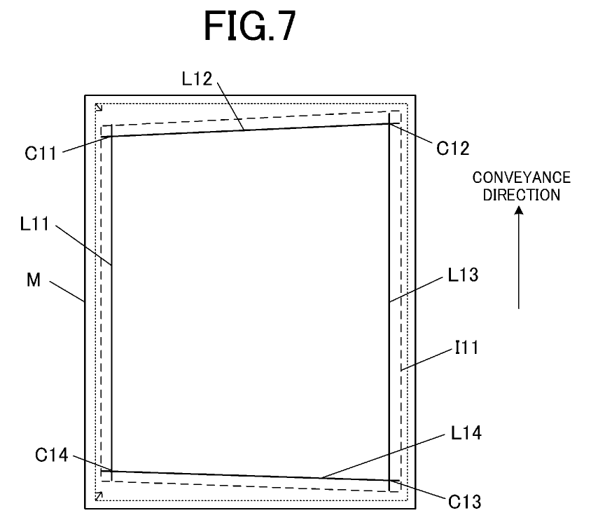

As illustrated in FIG. 6A, the formed image can be reduced or enlarged relative to the reference image. Here, the test image I11 has a size smaller than the original image size indicated by the dotted line. As illustrated in FIG. 6B, the width of the formed image in the conveyance direction may vary. Here, the test image I11 may have a trapezoidal shape. In this case, it is only required that the enlargement/reduction ratio is obtained separately for each of the side L12 and the side L14. As illustrated in FIG. 7, the widths of the trapezoidal shapes in the conveyance direction may be different between the side L11 and the side L13. The above five patterns may occur in combination.

Based on the reading results obtained in this way, the output image may be deformed and adjusted to offset the misregistration amount. That is, when there is a rotational misregistration of the rotation angle θ, the image data in which the original image is rotated backward by an angle "-θ" is output as the target data for image formation, thereby reducing the image formation misregistration. When the misregistration in the width direction is "dH", the misregistration of the image formation position is reduced by using the image data in which the image formation position is deviated by "-dH" from the original position as the image formation target data.

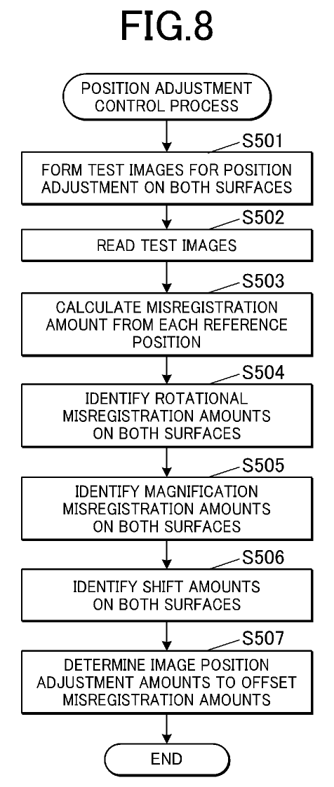

FIG. 8 is a flowchart illustrating a control procedure of a position adjustment control process. The position adjustment control process corresponds to the adjustment step (P1) according to the present embodiment.

The CPU 151 causes the image forming operation section 11 to form the test images I11 and I12 for position adjustment on both surfaces of the medium for adjustment (S501). The CPU 151 causes the image reading sections 24 and 25 to read the test images I11 and I12, respectively (S502). The CPU 151 calculates the misregistration amounts of the intersections C11 to C14 and C21 to C24 from the reference positions (S503).

The CPU 151 identifies the rotational misregistration amounts of the formed images on both surfaces based on the above misregistration amounts (S504). The CPU 151 identifies the magnification misregistration amounts, that is, size misregistration amounts of the formed images on both surfaces based on the above misregistration amounts (S505). The CPU 151 identifies the shift amounts of the image on both surfaces, that is, the parallel shift amounts based on the misregistration amounts (S506). Note that the CPU 151 may obtain the misregistration amounts identified in steps S504 to S506 collectively or in an order different from the above.

Based on the above misregistration amounts, the CPU 151 determines image position adjustment amounts to offset the misregistration amounts (S507). Next, the CPU 151 ends the position adjustment control process.

Such adjustment is performed on a specific medium used for image diagnosis among the media supplied from the plurality of feeding trays 12a. That is, the image formation position may be adjusted only for the specific medium. After the image formation position is adjusted, image diagnosis is performed on the medium for which the image formation position has been adjusted.

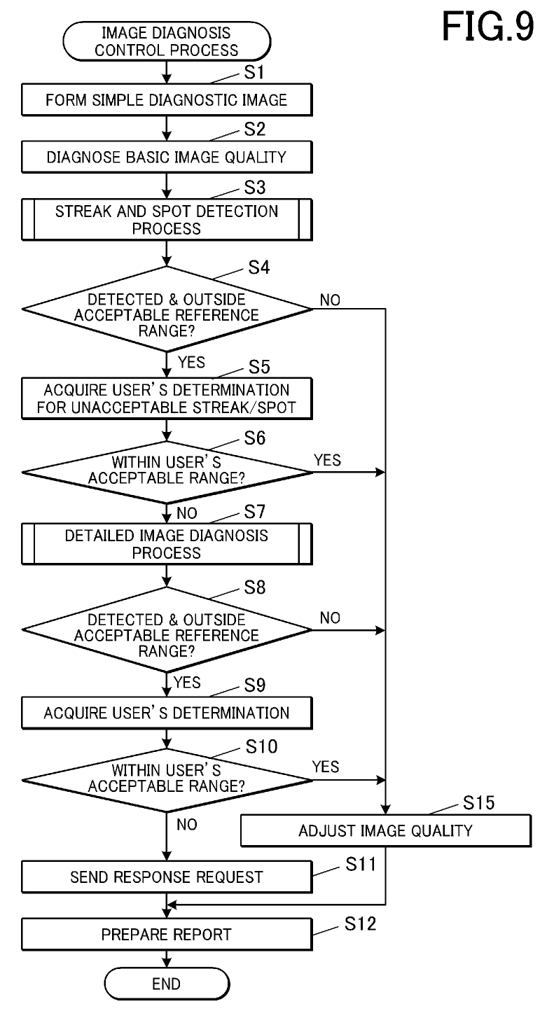

FIG. 9 is a flowchart illustrating a procedure of an image diagnosis control process. The image diagnosis control process includes the diagnosis step P2 and P3 according to the present embodiment.

As described above, the image diagnosis is performed after the position adjustment is performed.

The CPU 151 causes the image forming operation section 11 to form a simple diagnostic image (S1). The CPU 151 acquires a read image of the formed simple diagnostic image from the reading device 20 to perform diagnosis of the basic image quality (S2). The CPU 151 performs a streak and spot detection process using the simple diagnostic image (S3).

The CPU 151 determines whether a streak or a spot is detected and whether the number, the size, the density, or the like of the detected streak or spot is outside a predetermined acceptable reference range (S4). If the CPU 151 determines that a streak or a spot is not detected or it is within the acceptable reference range even when a streak or a spot is detected (S4; NO), the process of the CPU 151 proceeds to step S15.

In step S15, the CPU 151 adjusts the image quality according to the results of the basic image quality diagnosis (S15). Then, the process of the CPU 151 proceeds to step S12.

If the CPU 151 determines that a streak or a spot is detected and the streak or the spot is outside the acceptable reference range (S4; YES), the process of CPU 151 proceeds to step S5. In step S5, the CPU 151 requests a user to make determination and acquires the determination content (S5). For example, the CPU 151 causes the display part 142 to display an image or the like of the detection results of the streak and the spot and requests a selection operation as to whether to accept the results. The CPU 151 acquires the user’s determination in response to an input operation received by the operation reception section 141. Alternatively, it is also conceivable that the user may not be near the image forming apparatus 1. In this case, for example, the image of the detection results of the streak and the spot may be compiled into a report format or registered in a predetermined access server or the like, and communication may be sent to the user requesting confirmation via e-mail, SNS, or the like. After remotely confirming the image of the detection results, the user may be guided to perform an input operation of selecting whether it is within the acceptable range on a predetermined website or the like.

The CPU 151 determines whether the acquired determination result is "within the user’s acceptable range" (S6). If the CPU 151 determines that it is within the user's acceptable range (S6; YES), the process of the CPU 151 proceeds to step S15. If the CPU 151 determines that it is not within the user's acceptable range (S6; NO), the CPU 151 performs detailed image diagnosis and acquires the diagnosis result (S7).

Based on the results of the detailed image diagnosis, the CPU 151 determines whether a streak and/or a spot is continuously detected and whether the streak and/or the spot is outside the predetermined acceptable reference range (S8). If the CPU 151 determines that a streak or a spot is no longer detected or that the detected streak and/or spot is within the acceptable reference range (S8; YES), the process of the CPU 151 proceeds to step S15.

If the CPU 151 determines that a streak and a spot are detected and the detected streak and spot are outside the acceptable reference range (S8; NO), the CPU 151 requests the user to make determination and acquires the user’s determination (S9). The CPU 151 causes, for example, the display part 142 to display an image or the like of the detection results of the streak or the spot and requests a selection operation as to whether to accept the results. The CPU 151 acquires the user’s determination in response to an input operation received by the operation reception section 141. Alternatively, assuming the case where the user is not near the image forming apparatus 1, the image of the detection results of the streak or the spot may be compiled into a report format or registered in a predetermined access server or the like. The CPU 151 may send communication requesting the user to confirm the report or the registered contents via e-mail, SNS, or the like. After remotely confirming the image of the detection results, the user may be guided to perform an input operation of selecting whether it is within the acceptable range on a predetermined website or the like.

The CPU 151 determines, based on the acquired user’s determination result, whether the streak and the spot are within the user’s acceptable range (S10). If the CPU 151 determines that it is within the user's acceptable range (S10; YES), the process of the CPU 151 proceeds to step S15. If the CPU 151 determines that it is not within the user's acceptable range (S10; NO), the CPU 151 contacts a professional staff member or service person to address the cause of the streak or the spot. Alternatively, the CPU 151 sends a response request to the user requesting communication (S11). The CPU 151 may transmit a notification to a staff dispatch office or the like via the network or may display a contact telephone number or the like on the display part 142 and request the user to make a phone call. As described below, when the identified cause of the streak or the spot is mechanically addressable, i.e., do not require user action, the image forming apparatus 1 may perform the action automatically. For example, when contamination of a particular component is mechanically removable, the image forming apparatus 1 may perform cleaning of the component. Then, the process of the CPU 151 proceeds to step S12.

In step S12, the CPU 151 prepares a report on the diagnosis result (S12). The CPU 151 compiles in the report analysis parameters related to the diagnosis such as the basic image quality, adjustment amounts of the parameters, a detected image of a streak or a spot, analysis parameters, the degree of recovery, the presence or absence of a final communication with staff, and the like. The report may be prepared according to a predetermined format. Then, the CPU 151 ends the image diagnosis control process.

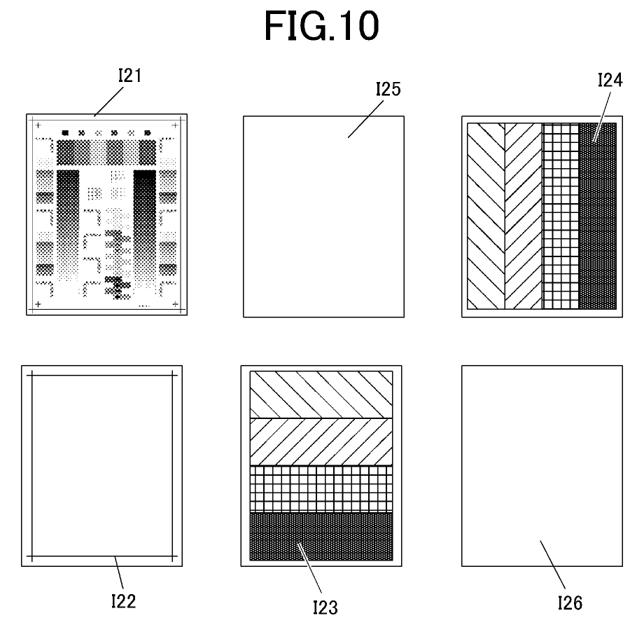

FIG. 10 is a diagram illustrating an example of a second test image for the simple image diagnosis.

The second test image (second pattern) is a simple diagnostic image for diagnosing the state of the image forming operation section 11. The second test image may be formed on, for example, both surfaces of each of three sheets of the medium M (second medium), that is, six surfaces in total. A first chart I21 including various images for the simple image diagnosis, such as a patch image and a density gradation image, is formed on the front surface of the first sheet of the medium M. The diagnostic targets may be, for example, developing memory, graininess,

maximum density, in-plane color difference, gradation, line width, color misregistration, and edge quality of patch. For these diagnoses, well-known technologies may be used. A second chart I22 for diagnosing whether the position adjustment has been accurately performed is formed on the back surface of the first sheet. The second chart I22 may have the same pattern as the first test image. The identification of the misregistration amount may be performed by the same method as the identification using the first test image.

In the simple image diagnosis, a streak and noise are also detected. The streak includes a longitudinal streak, that is, an FD streak along the conveyance direction (Feed Direction) and a transverse streak, that is, a CD streak along the Cross Direction intersecting the conveyance direction. A third chart I23 including halftone images of the respective colors of YMCK extending in the conveyance direction for detecting a FD streak is formed on the back surface of the second sheet of the medium M. The third chart I23 can also be used to adjust the density balance.

A fourth chart I24 including halftone images of the respective colors of YMCK extending in the width direction for detecting a CD streak is formed on the front surface of the third sheet. The densities of the halftone images in the third chart I23 and the fourth chart I24 may be uniform and may be 50%, for example. Alternatively, the density of the halftone image may be different for each color of CMYK. In the third chart I23 and the fourth chart I24, which are diagnosis patterns for the image noise, a spot dirt, a spot, an oblique streak other than in the FD and the CD, and the like may also be detected.

White images I25 and I26 are formed on the front surface of the second sheet of the medium M and the back surface of the third sheet of the medium M, respectively. That is, the medium M passes through the image forming operation section 11 and the fixing section 112 along the conveyance path 130, and the image forming operation is performed on the medium M, but no toner is applied to the medium M based on the image data. As a result, dirt attached at each section along the conveyance path 130 during the image formation is detected.

The FD streak appears at a specific position in the width direction and does not move. Therefore, the FD streak can be detected without omission by forming the third chart I23 across the entire width in the width direction. The FD streak is an abnormality that occurs over some sustained period of time, for example, a toner leak. The CD streak is not continuous in the conveyance direction but may appear periodically or irregularly or singly.

The streak or the spot may be ranked in a plurality of predetermined stages according to the size, the density ratio, and the like. The acceptable reference range that the CPU 151 uses to mechanically determine whether it is within the acceptable range may be changeable automatically according to a rank accepted by the user or manually in response to an input operation by the user. The rank may be defined such that the larger the rank is, the more remarkable the streak or spot is.

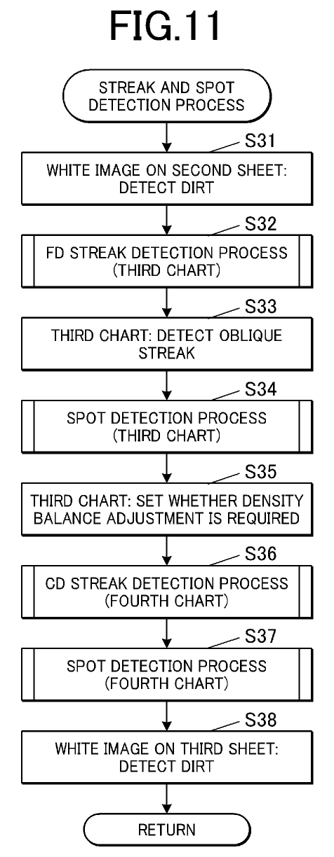

FIG. 11 is a flowchart illustrating a control procedure of the streak and spot detection process executed in the image diagnosis control process. The CPU 151 detects dirt using the white image I25 of the second test image (S31). The CPU 151 executes an FD streak detection process using the third chart I23 (S32). The CPU 151 detects an oblique streak using the third chart I23 (S33). The CPU 151 executes a spot detection process using the third chart I23 (S34). The CPU 151 sets whether density balance adjustment is necessary using the third chart I23 (S35).

The CPU 151 executes a CD streak detection process using the fourth chart I24 (S36). CPU 151 executes the spot detection process using the fourth chart I24 (S37). The CPU 151 detects dirt using the white image I26 (S38). Next, the process of the CPU 151 returns to the image diagnosis control process.

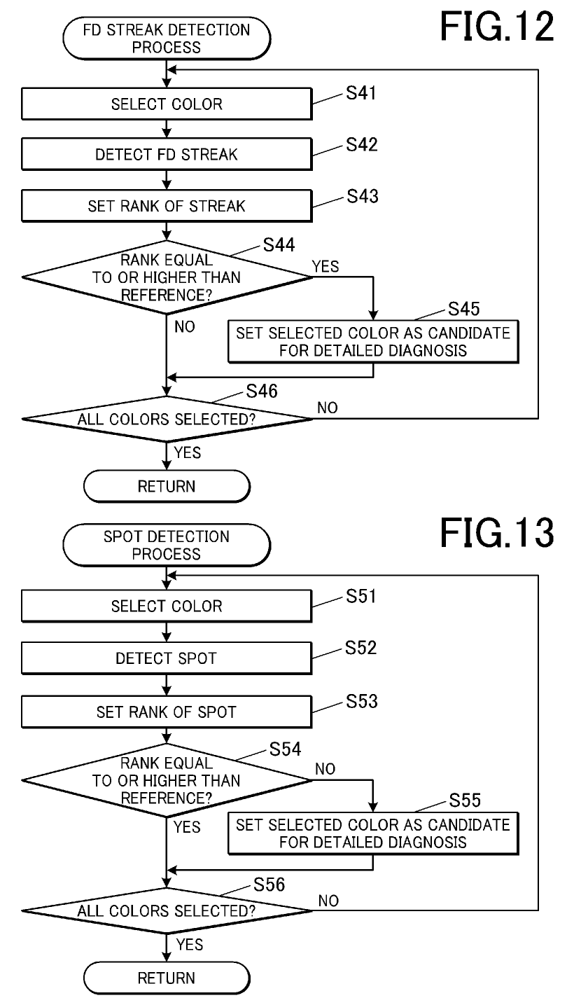

FIG. 12 is a flowchart illustrating a control procedure of the FD streak detection process executed in the streak and spot detection process. The CPU 151 selects each color of CMYK in turn (S41). The CPU 151 detects an FD streak from the halftone image of the selected color (S42). For example, the CPU 151 may determine that an FD streak occurs when the CPU 151 detects density abnormalities on multiple lines extending in the width direction and determines that the detected positions of the density abnormalities are at the same position on the multiple lines.

The CPU 151 sets the rank of the FD streak as described above based on the thickness and the density of the detected FD streak (S43). The CPU 151 determines whether the rank is equal to or higher than a reference value, that is, whether the FD streak is more prominent than a reference level corresponding to the reference value (S44). If the CPU 151 determines that the rank is equal to or higher than the reference value (S44; YES), the CPU 151 sets the selected color as a candidate for detailed diagnosis (S45). Then, the process of the CPU 151 proceeds to step S46. If the CPU 151 determines that the rank is not equal to or higher than the reference value (S44; NO), the process of CPU 151 proceeds to step S46.

In step S46, the CPU 151 determines whether all the colors have been selected (S47). If the CPU 151 determines that all the colors have not been selected, that is, there is an unselected color (S47; NO), the process of the CPU 151 returns to step S41. If the CPU 151 determines that all the colors have been selected (S47; YES), the CPU 151 ends the FD streak detection process and returns the process to the streak and spot detection process.

FIG. 13 is a flowchart illustrating a control procedure of the spot detection process called in the streak and spot detection process.

The CPU 151 selects each color of CMYK in turn (S51). The CPU 151 detects a spot from the halftone image of the selected color (S52). The CPU 151 detects a two-dimensionally isolated point that is a local abnormality of the selected color from the halftone image of the selected color. The CPU 151 sets the rank of the detected spot (S53).

The CPU 151 determines whether the rank of each detected spot is equal to or higher than a reference value (S54). If the CPU 151 determines that at least one of the detected spots has a rank equal to or higher than the reference value (S54; YES), the CPU 151 sets the selected color as a candidate for detailed diagnosis (S55). Then, the process of the CPU 151 proceeds to step S56. If the CPU 151 determines that all the ranks of the detected spots are lower than the reference value (S54; NO), the process of the CPU 151 proceeds to step S56. In step S56, the CPU 151 determines whether all the colors have been selected (S56). If the CPU 151 determines that there is an unselected color (S56; NO), the process of the CPU 151 returns to step S51. If the CPU 151 determines that all the colors have been selected (S56; YES), the CPU 151 ends the spot detection process, and returns the process to the streak and spot detection process.

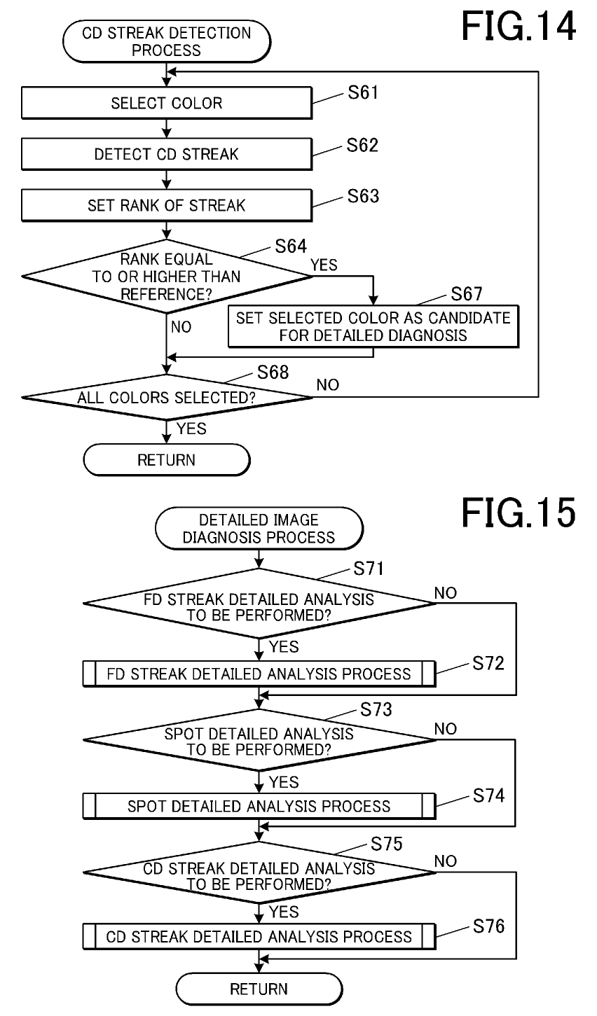

FIG. 14 is a flowchart illustrating a control procedure of the CD streak detection process.

The CD streak detection process is called in the streak and spot detection process.

The CPU 151 selects each color of CMYK in turn (S61). The CPU 151 detects a CD streak from the halftone image of the selected color (S62). The CPU 151 detects a streak extending in the width direction. The CPU 151 sets the rank of the detected CD streak (S63).

The CPU 151 determines whether the rank of each detected CD streak is equal to or higher than a reference value (S64). If the CPU 151 determines that at least one of the detected CD streaks has a rank equal to or higher than the reference value (S64; YES), the CPU 151 sets the selected color as a candidate for detailed diagnosis (S67). Then, the process of the CPU 151 proceeds to step S68. If the CPU 151 determines that all the ranks of the detected CD streaks are lower than the reference value (S64; NO), the process of the CPU 151 proceeds to step S68. In step S68, the CPU 151 determines whether all the colors have been selected (S68). If the CPU 151 determines that there is an unselected color (S68; NO), the process of the CPU 151 returns to step S61. If the CPU 151 determines that all the colors have been selected (S68; YES), the CPU 151 ends the CD detection process, and returns the process to the streak and spot detection process.

FIG. 15 is a flowchart illustrating a control procedure of the detailed image diagnosis process called in the image diagnosis control process.

The CPU 151 determines whether detailed analysis of an FD streak is set to be performed (S71). If the CPU 151 determines that the detailed analysis of an FD streak is set to be performed (S71; YES), the CPU 151 executes an FD streak detailed analysis process (S72). Thereafter, the process proceeds to step S73. If the CPU 151 determines that the detailed analysis of an FD streak is not set to be performed (S71; NO), the process proceeds to step S73.

The CPU 151 determines whether detailed analysis of a spot is set to be performed (S73). If the CPU 151 determines that the detailed analysis of a spot is set to be performed (S73; YES), the CPU 151 executes a spot detailed analysis process (S74). Then, the process proceeds to step S75. If the CPU 151 determines that the detailed analysis of a spot is not set to be performed (S73; NO), the process of the CPU 151 proceeds to step S74.

The CPU 151 determines whether detailed analysis of a CD streak is set to be performed (S75). If the CPU 151 determines that the detailed analysis of a CD streak is set to be performed (S75; YES), the CPU 151 executes a CD streak detailed analysis process (S76). Then, the CPU 151 ends the detailed image diagnosis process and returns the process to the streak and spot detection process. If the CPU 151 determines that the detailed analysis of a CD streak is not set to be performed (S75; NO), the CPU 151 ends the detailed image diagnosis process and returns the process to the streak and spot detection process.

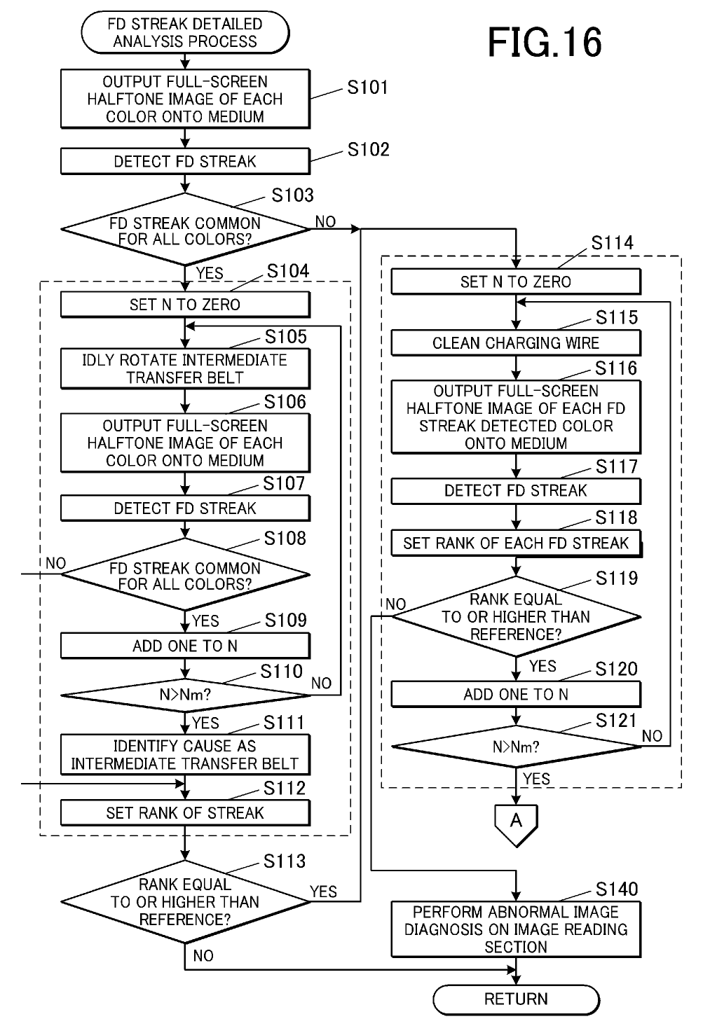

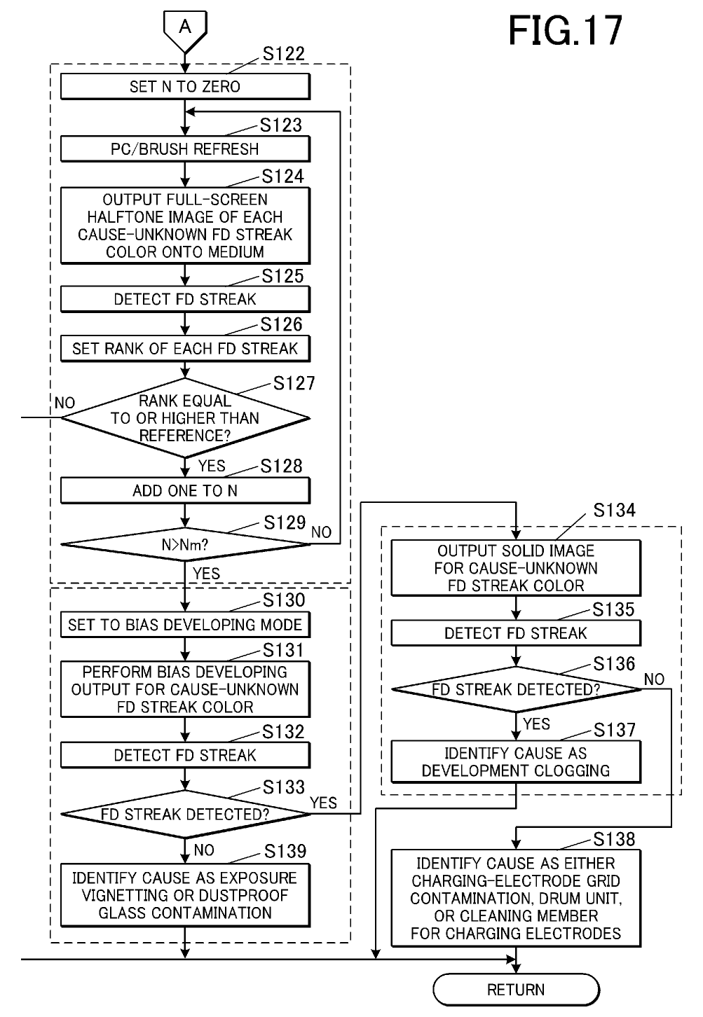

FIG. 16 and FIG. 17 are flowcharts illustrating a control procedure of the FD streak detailed analysis process executed in the detailed image diagnosis process.

The CPU 151 causes the image forming operation section 11 to output the halftone image of each color of CMYK onto the medium in full screen (S101). That is, the image forming operation section 11 outputs four sheets of full-screen halftone images. The CPU 151 detects an FD streak from each halftone image (S102).

The CPU 151 determines whether there is an FD streak at a common position in the width direction for all the colors (S103). If the CPU 151 determines that there is no FD streak at a common position (S103; NO), the process of CPU 151 proceeds to step S114.

If the CPU 151 determines that there is a component in a FD streak that is located at a common position in the width direction for all the colors (S103; YES), the CPU 151 sets the value of variable N to "0" (S104). The CPU 151 causes the intermediate transfer belt 11b to rotate idly (S105). The CPU 151 again causes the full-screen halftone image of each color of CMYK to be output onto the medium (S106). The CPU 151 detects an FD streak from the halftone image of each color (S107).

The CPU 151 determines whether there is an FD streak at a common position in the width direction for all the colors (S108). If the CPU 151 determines that there is no FD streak at a common position for all the colors (S108; NO), the process of CPU 151 proceeds to step S112.

If the CPU 151 determines that there is an FD streak at a common position for all the colors (S108; YES), the CPU 151 adds 1 to the variable N (S109). The CPU 151 determines whether the variable N is greater than an upper limit value Nm (S110). If the CPU 151 determines that the variable N is not greater than the upper limit value Nm (S110; NO), the process of the CPU 151 returns to step S105. That is, the upper limit value Nm is the upper limit number of idle rotations of the intermediate transfer belt in step S105.

If the CPU 151 determines that the variable N is greater than the upper limit value Nm (S110; YES), the CPU 151 identifies the cause of the FD streak as the intermediate transfer belt 11b (S111). In the case where the intermediate transfer belt 11b is the cause, the intermediate transfer belt 11b is often damaged. Then, the process of the CPU 151 proceeds to step S112.

In S112, the CPU 151 sets the rank of each FD streak (S112). The CPU 151 determines whether there is an FD streak having a rank equal to or higher than the reference value (S113). If the CPU 151 determines that there is no FD streak having a rank equal to or higher than the reference value (S113; NO), the CPU 151 ends the FD streak detailed analysis process and returns the process to the detailed image diagnosis process.

If the CPU 151 determines that there is an FD streak having a rank equal to or higher than the reference value (S113; YES), the CPU 151 sets the variable N to "0" (S114). The CPU 151 cleans a charging wire related to charging of the photoreceptors or the like (S115). When the image forming apparatus 1 does not have a mechanism for automatically cleaning the charging wire, the CPU 151 may perform a notification operation of requesting the user to clean the charging wire by means of the display part 142 or the like.

After the cleaning of the charging wire, the CPU 151 causes the image forming operation section 11 to output the full-screen halftone image of the color for which the FD streak has been detected onto the medium (S116). The CPU 151 detects an FD streak from a read image of the output halftone image (S117). The CPU 151 sets the rank of each read FD streak (S118). The CPU 151 determines whether there is an FD streak having a rank equal to or higher than the reference value (S119). If the CPU 151 determines that all the ranks of the FD streaks are not equal to or higher than the reference value (S119; NO), the cause of the abnormality is the charging wire. The CPU 151 performs abnormal image diagnosis on the reading device 20 (S140). Then, the CPU 151 ends the FD streak detailed analysis process and returns the process to the detailed image diagnosis process.

If the CPU 151 determines that the rank of at least one of the FD streaks is equal to or higher than the reference value (S119; YES), the CPU 151 adds 1 to the variable N (S120). The CPU 151 determines whether the variable N is greater than an upper limit value Nm (S121). Note that the upper limit value Nm may be different from the upper limit Nm value in step S110. If the CPU 151 determines that the variable N is not greater than the upper limit value Nm (S121; NO), the process of the CPU 151 returns to step S115.

If the CPU 151 determines that the variable N is greater than the upper limit value Nm (S121; YES), the process proceeds to FIG. 17, and the CPU 151 sets the variable N to "0" (S122). The CPU 151 performs PC/brush refresh (S123). The CPU 151 causes the image forming operation section 11 to output the full-screen halftone image of the color for which the cause of the FD streak has not yet been identified onto the medium (S124). The CPU 151 detects an FD streak (S125).

The CPU 151 sets the rank of each detected FD streak (S126). The CPU 151 determines whether there is an FD streak having a rank equal to or higher than the reference value (S127). If the CPU 151 determines that there is no FD streak having a rank equal to or higher than the reference value (S127; NO), the CPU 151 ends the FD streak detailed analysis process and returns the process to the detailed image diagnosis process.

If the CPU 151 determines that there is an FD streak having a rank equal to or higher than the reference value (S127; YES), the CPU 151 adds 1 to the variable N (S128). The CPU 151 determines whether the variable N is greater than an upper limit value Nm (S129). The upper limit value Nm may be different from either or both of the upper limit values Nm in steps S110 and S121. If the CPU 151 determines that the variable N is not greater than the upper limit value Nm (S129; NO), the process of the CPU 151 returns to step S123.

If the CPU 151 determines that the variable N is greater than the upper limit value Nm, the CPU 151 sets the image forming apparatus 1 to a bias developing mode in which charging and exposure of the photoreceptors 11a are not used (S130). The CPU 151 causes the image forming operation section 11 to output an image by bias development output for the color for which the cause of the FD streak has not yet been determined (S131). The CPU 151 detects an FD streak from the output image (S132).

The CPU 151 determines whether an FD streak has been detected (S133). If the CPU 151 determines that no FD streak has been detected (S133; NO), the cause of the FD streak is set to exposure vignetting or dustproof glass contamination (S139). The CPU 151 ends the FD streak detailed analysis process and returns the process to the detailed image diagnosis process.

If the CPU 151 determines that an FD streak has been detected (S133; YES), the CPU 151 causes a solid image to be output by normal development for the color for which the cause of the FD has not been identified (S134). The CPU 151 detects an FD streak from a read image of the solid image (S135). The CPU 151 determines whether there is an FD streak (S136). If the CPU 151 determines that there is an FD streak (S136; YES), the cause of the FD streak is set to a development clogging (S137). The CPU 151 ends the FD streak detailed analysis process and returns the process to the detailed image diagnosis process. If the CPU 151 determines that there is no FD streak (S136; NO), the cause is determined to be either charging-electrode grid contamination, a drum unit, or a cleaning member for charging electrodes (S138). The CPU 151 ends the FD streak detailed analysis process and returns the process to the detailed image diagnosis process.

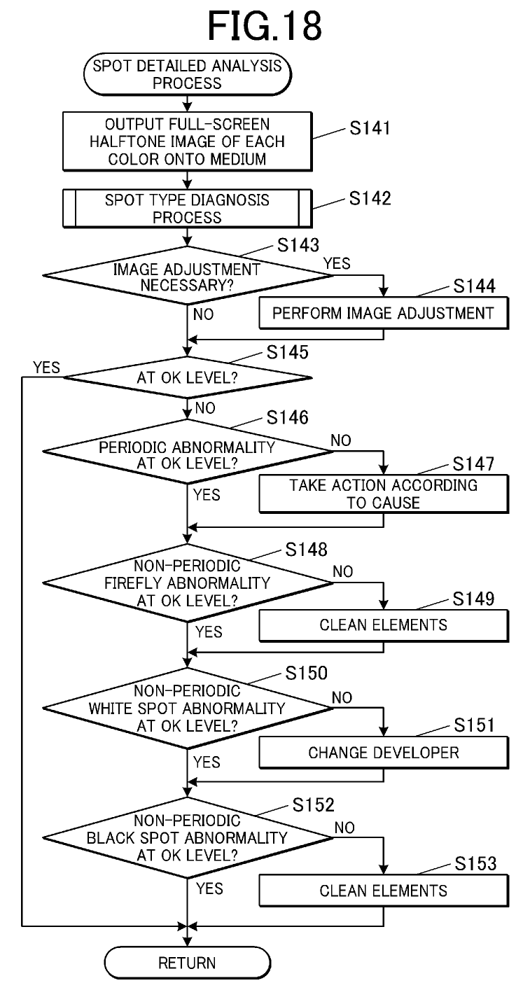

FIG. 18 is a flowchart illustrating a control procedure of the spot detailed analysis process executed in the detailed image diagnosis process.

The CPU 151 causes the image forming operation section 11 to output the full-screen halftone image of each color onto the medium (S141). The CPU 151 executes a spot type diagnosis process to be described later (S142).

The CPU 151 determines whether the image adjustment has been set as necessary in the spot type diagnosis process (S143). If the image adjustment has been set as necessary (S143; YES), the CPU 151 performs the image adjustment (S144). The image adjustment may include, for example, calibration and maximum density adjustment. These include adjustments according to the output control performed in the spot type diagnosis process. The process of the CPU 151 proceeds to step S145. If the image adjustment has not been set as necessary (S143; NO), the process of the CPU 151 proceeds to step S145.

In step S145, the CPU 151 determines whether the spot set in the spot type diagnosis process is at an OK level, that is, whether the rank is equal to or less than the reference (S145). If the CPU 151 determines that it is at the OK level (S145; YES), the CPU 151 ends the spot detailed analysis process and returns the process to the detailed image diagnosis process.

If the CPU 151 determines that the spot is not at the OK level (S145; NO), the CPU 151 determines whether there is no periodic abnormality detected in the spot type diagnosis process or whether a periodic abnormality detected in the spot type diagnosis process is at an OK level (S146). Examples of locations that can cause periodic spots include a drum unit, a developing unit, an intermediate transfer belt, an intermediate transfer drive roller, a primary transfer roller, an upper fixing roller, and a lower fixing roller. The appearance cycle of the spots varies depending on the location of the cause. Therefore, by identifying the appearance cycle, the location of the cause can be identified. These correspondences may be stored in the feature information 153b, and the CPU 151 may refer to the feature information 153b as necessary. If the CPU 151 determines that the periodic abnormality is not at the OK level (S146; NO), the CPU 151 takes action according to the location of the cause corresponding to the above-described cycle (S147). When the CPU 151 cannot directly control the contents of the action, the CPU 151 may cause the display part 142 to display the contents of the action and request the user to take the action. The process of the CPU 151 proceeds to step S148. If the CPU 151 determines that the periodic abnormality is at the OK level (S146; YES), the process of the CPU 151 proceeds to step S148.

In step S148, the CPU 151 determines whether a non-periodic firefly is at an OK level (S148). If the CPU 151 determines that the non-periodic firefly is not at the OK level (S148; NO), the CPU 151 executes or makes a notification about cleaning of the constituent elements related to the image forming operation (S149). The process of

the CPU 151 proceeds to step S150. If the CPU 151 determines that the non-periodic firefly is at the OK level or a non-periodic firefly is not detected (S148; YES), the process of the CPU 151 proceeds to step S150.

In step S150, the CPU 151 determines whether a non-periodic white spot is at an OK level (S150). If the CPU 151 determines that the non-periodic white spot is not at the OK level (S150; NO), the CPU 151 performs a notification operation prompting a change of a developer (S151). The notification operation may be a display operation performed by the display part 142. The process of the CPU 151 proceeds to step S152. If the CPU 151 determines that the non-periodic white spot is at the OK level or a non-periodic white spot is not detected (S150; YES), the process of the CPU 151 proceeds to step S152.

In step S152, the CPU 151 determines whether a non-periodic black spot is at an OK level (S152). If the CPU 151 determines that the non-periodic black spot is not at the OK level (S152; NO), the CPU 151 executes or makes a notification about cleaning of the constituent elements related to the image forming operation (S153). The CPU 151 ends the spot detailed analysis process and returns the process to the detailed image diagnosis process. If the non-periodic black spot is at the OK level or a non-periodic black spot is not detected (S152; YES), the CPU 151 ends the spot detailed analysis process and returns the process to the detailed image diagnosis process.

Examples of the non-periodic spot include, for example, a spot caused by a developer, a duplex unit, or the like. Such non-periodic spots can be dealt with to the extent that they can be distinguished by the type of firefly or spot. However, it is difficult to identify and deal with non-periodic spots that have a plurality of causes.

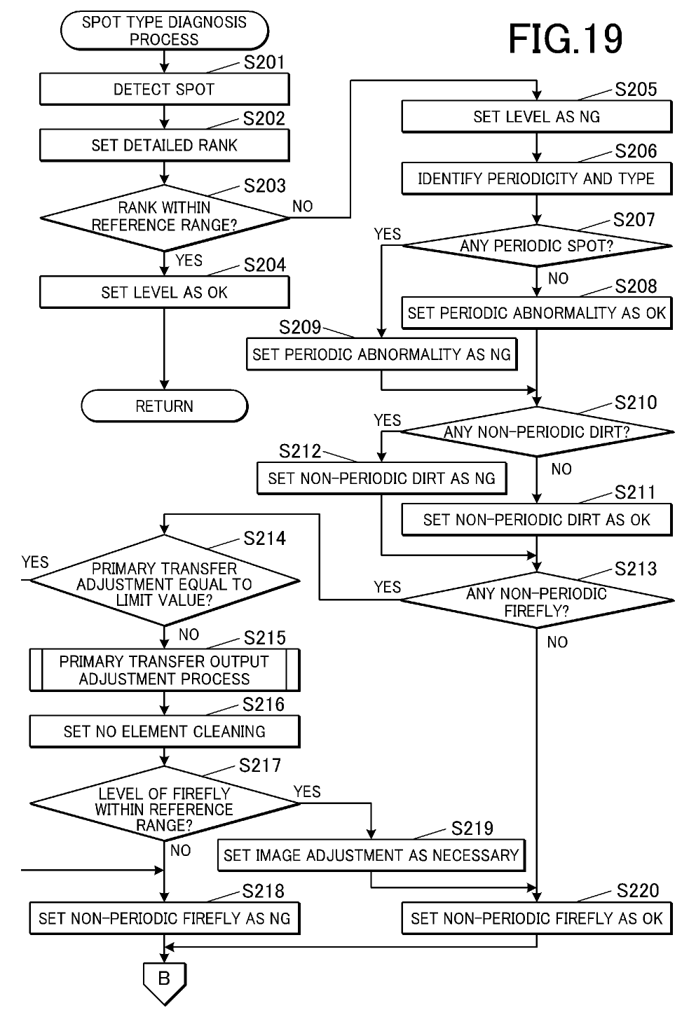

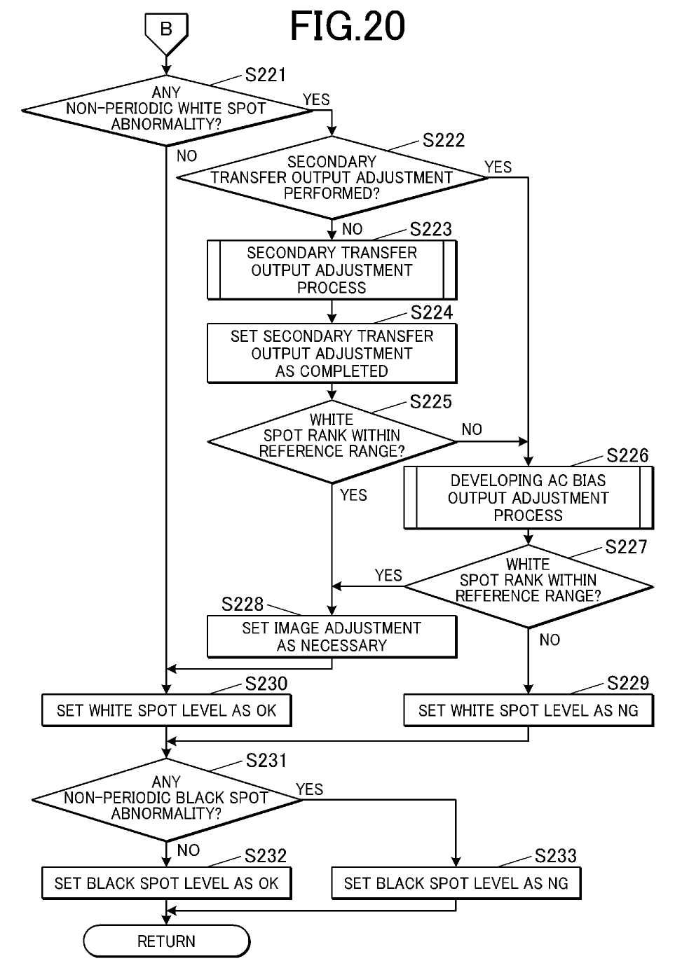

FIGS. 19 and 20 are flowcharts illustrating a control procedure of the spot type diagnosis process executed in the spot detailed analysis process. The CPU 151 detects a spot using the halftone image formed in step S141 (S201). CPU 151 sets the detailed rank of each spot (S202). The CPU 151 determines whether the detailed rank is within a reference range (S203). If the CPU 151 determines that the detailed rank is within the reference range (S203; YES), the CPU 151 sets the level of the spot as OK (S204). Then, the CPU 151 ends the spot type diagnosis process and returns the process to the detailed image diagnosis process.

If the CPU 151 determines in the determination process of step S203 that the detailed rank of the spot is not within the reference range (S203; NO), the CPU 151 sets the level of the spot as NG (S205). The CPU 151 identifies the periodicity and type of each spot (S206). The periodicity is obtained by mapping the appearance positions of the spots to the positions in the conveyance direction as described above. The cause of the occurrence of the spots is identified according to the periodicity.

The CPU 151 determines whether there is a periodic spot (S207). If the CPU 151 determines that there is no periodic spot (S207; NO), the CPU 151 sets periodic abnormality as OK (S208). If the CPU 151 determines that there is a periodic spot (S207; YES), the CPU 151 sets the periodic abnormality as NG (S209). After each of steps S208 and 209, the process of the CPU 151 proceeds to step S210.

In step S210, the CPU 151 determines whether there is non-periodic dirt (S210). If the CPU 151 determines that there is no non-periodic dirt (S210; NO), the CPU 151 sets non-periodic dirt as OK (S211). If the CPU 151 determines that there is non-periodic dirt (S210; YES), the CPU 151 sets the non-periodic dirt as NG (S212). After each of steps S211 and S212, the process of the CPU 151 proceeds to step S213.

In step S213, the CPU 151 determines whether there is a non-periodic firefly (S213). If the CPU 151 determines that there is no non-periodic firefly (S213; NO), the CPU 151 sets non-periodic firefly as OK (S220). Then, the process of the CPU 151 proceeds to step S221. If the CPU 151 determines that there is a non-periodic firefly (S213; YES), the CPU 151 determines whether the adjustment value for primary transfer output is a limit value (S214). If the CPU 151 determines that it is the limit value (S214; YES), the process of the CPU 151 proceeds to step S218. If the CPU 151 determines that it is not the limit value (S214; NO), the CPU 151 executes a primary transfer output adjustment process (S215). The CPU 151 sets no element cleaning (S216).

The CPU 151 determines whether the level of the firefly acquired in the primary transfer output adjustment process is within a reference range (S217). If the CPU 151 determines that the level of the firefly is within the reference range (S217; YES), the CPU 151 sets the image adjustment as necessary (S219). Then, the process of the CPU 151 proceeds to step S220. If the CPU 151 determines that the level of the firefly is not within the reference range (S217; NO), the CPU 151 sets non-periodic firefly as NG (S218). Then, the process of the CPU 151 proceeds to S221.

In step S221, the CPU 151 determines whether there is a non-periodic white spot abnormality (S221). If the CPU 151 determines that there is no non-periodic white spot (S221; NO), the CPU 151 sets white spot level as OK (S230). Thereafter, the process of the CPU 151 proceeds to step S231.

If the CPU 151 determines that there is a non-periodic white spot (S221; YES), the CPU 151 determines whether secondary transfer output adjustment has already been performed (S222). If the CPU 151 determines that the secondary transfer output adjustment has already been performed (S222; YES), the CPU 151 executes a developing AC bias output adjustment process, which is adjustment of the AC component of the developing bias (S226).

If the CPU 151 determines that the secondary transfer output adjustment has not been performed (S222; NO), the CPU 151 executes a secondary transfer output adjustment process (S223). The CPU 151 sets that the secondary transfer output adjustment has been completed (S224). The CPU 151 determines whether the white spot rank set in the secondary transfer output adjustment process is within a reference range (S225). If the CPU 151 determines that the white spot rank is within the reference range (S225; YES), the CPU 151 sets the image adjustment as necessary (S228). Then, the process of the CPU 151 proceeds to step S230.

If the CPU 151 determines that the white spot rank is not within the reference range (S225; NO), the process of the CPU 151 proceeds to step S226. After the process of step S226, the CPU 151 determines whether the white spot rank is within the reference range (S227). If the CPU 151 determines that the white spot rank is within the reference range (S227; YES), the process of the CPU 151 proceeds to step S228. If the CPU 151 determines that the white spot rank is not within the reference range (S227; NO), the CPU 151 sets the white spot level as NG (S229). Thereafter, the process of the CPU 151 proceeds to step S231.

In step S231, the CPU 151 determines whether a non-periodic black spot has been detected (S231). If the CPU 151 determines that a black spot abnormality has been detected (S231; YES), the CPU 151 sets black spot level as NG (S233). If the CPU 151 determines that a black spot abnormality has not been detected (S231; NO), the CPU 151 sets the black spot level as OK (S232). The CPU 151 ends the spot type diagnosis process and returns the process to the spot detailed analysis process.

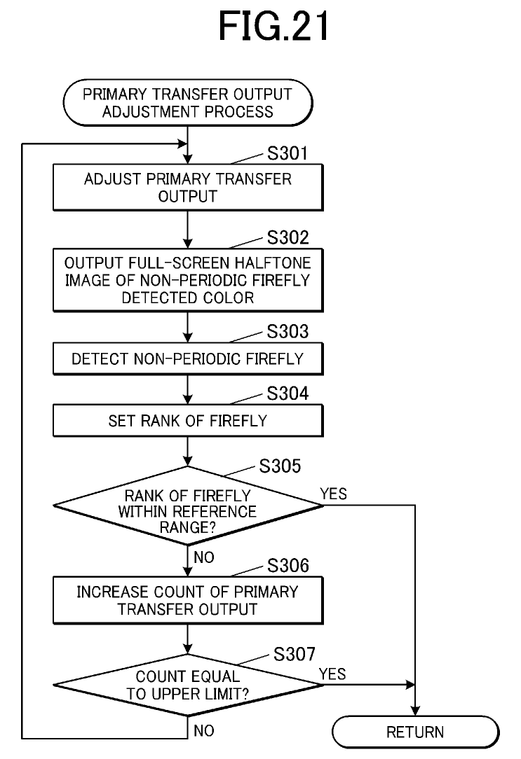

FIG. 21 is a flowchart illustrating a control procedure of the primary transfer output adjustment process executed in the spot type diagnosis process. The CPU 151 adjusts the primary transfer output (S301). The target of adjustment may be, for example, the voltage of a charging roller or the toner supply amount. The CPU 151 causes the image forming operation section 11 to output the full-screen halftone image of each toner color for which a non-periodic firefly has been detected onto the medium (S302).

The CPU 151 detects a non-periodic firefly from the output halftone image (S303). The CPU 151 sets the rank of each detected firefly (S304). The representative value of the rank may be the maximum value among the obtained ranks. The CPU 151 determines whether the rank of the firefly is within a reference range (S305). If the CPU 151 determines that the rank of the firefly is within the reference range (S305; YES), the CPU 151 ends the primary transfer output adjustment process and returns the process to the spot type diagnosis process.

If the CPU 151 determines that the rank of the firefly is not within the reference range (S305; NO), the CPU 151 increases a count value indicating the number of times the primary transfer output adjustment is performed by 1 (S306). The CPU 151 determines whether the count value is equal to a predetermined upper limit value (S307). If the CPU 151 determines that the count value is not equal to the upper limit value (S307; NO), the process of the CPU 151 returns to step S301. If the CPU 151 determines that the count value is equal to the upper limit value (S307; YES), the CPU 151 ends the primary transfer output adjustment process and returns the process to the spot type diagnosis process.

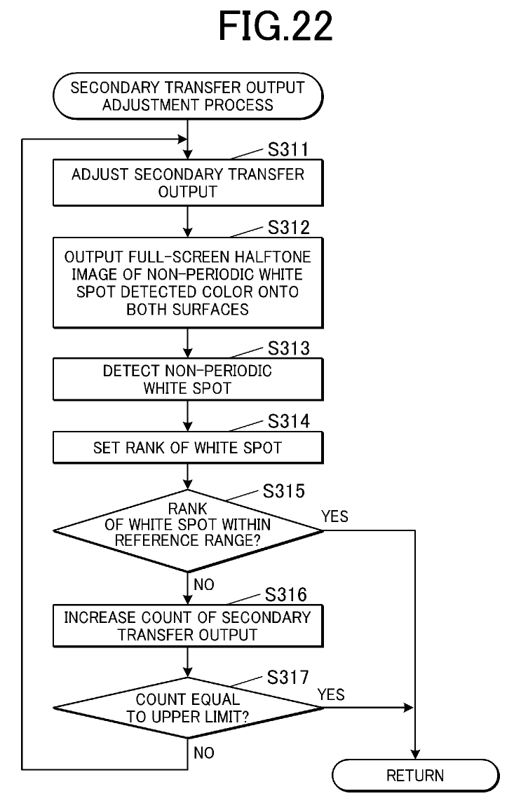

FIG. 22 is a flowchart illustrating a control procedure of the secondary transfer output adjustment process executed in the spot type diagnosis process. The CPU 151 adjusts the secondary transfer output (S311). The CPU 151 causes the image forming operation section 11 to output the full-screen halftone image of each toner color for which a non-periodic white spot has been detected onto both surfaces of the medium (S312). The CPU 151 detects a non-periodic white spot from the output halftone image (S313). The CPU 151 sets the rank of each detected white spot (S314).

The CPU 151 determines whether the rank of the white spot is within the reference range (S315). If the CPU 151 determines that the rank is within the reference range (S315; YES), the CPU 151 ends the secondary transfer output adjustment process and returns the process to the spot type diagnosis process. If the CPU 151 determines that the rank is not within the reference range (S315; NO), the CPU 151 increases a count value indicating the number of times the secondary transfer output adjustment is performed by 1 (S316). The CPU 151 determines whether the count value is equal to a predetermined upper limit value (S317). The upper limit value may be different from the upper limit value related to the number of times the primary transfer output adjustment process is executed. If the CPU 151 determines that the count value is not equal to the upper limit value (S317; NO), the process of the CPU 151 returns to step S311. If the CPU 151 determines that the count value is equal to the upper limit value (S317; YES), the CPU 151 ends the secondary transfer output adjustment process and returns the process to the spot type diagnosis process.

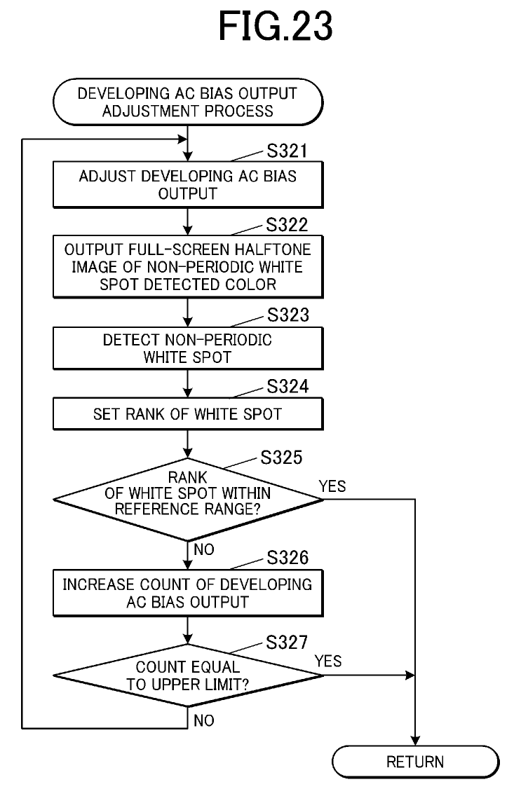

FIG. 23 is a flowchart illustrating a control procedure of the developing AC bias output adjustment process executed in the spot type diagnosis process.

The CPU 151 adjusts the output of the developing AC bias (S321). The CPU 151 causes the image forming operation section 11 to output the full-screen halftone image of each color for which a non-periodic white spot has been detected onto the medium (S322).

The CPU 151 detects a non-periodic white spot from the output halftone image (S323). The CPU 151 sets the rank of the detected white spot (S324). The CPU 151 determines whether the rank of the white spot is within the reference range (S325). If the CPU 151 determines that the rank of the white spot is within the reference range (S325; YES), the CPU 151 ends the developing AC bias output adjustment process and returns the process to the spot type diagnosis process.

If the CPU 151 determines that the rank of the white spot is not within the reference range (S325; NO), the CPU 151 increases a count value indicating the number of times the developing AC output adjustment is performed by 1 (S326). The CPU 151 determines whether the count value is equal to a predetermined upper limit value (S327). This upper limit value may be different from the upper limit value for the primary transfer output adjustment process or the upper limit value for the secondary transfer output adjustment process. If the CPU 151 determines that the count value is not equal to the upper limit value (S327; NO), the process of the CPU 151 returns to step S321. If the CPU 151 determines that the count value is equal to the upper limit value (S327; YES), the CPU 151 ends the developing AC bias output adjustment process and returns the process to the spot type diagnosis process.

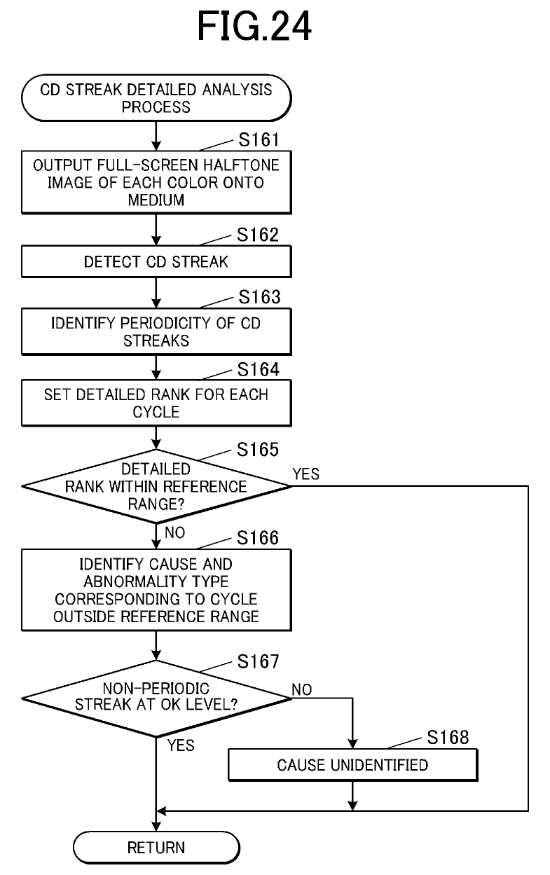

FIG. 24 is a flowchart illustrating a control procedure of the CD streak detailed analysis process executed in the detailed image diagnosis process.

The CPU 151 causes the image forming operation section 11 to output the full-screen halftone image of each color onto the medium (S161). The CPU 151 detects a CD streak from each halftone image (S162). The CPU 151 detects the periodicity of the detected CD streaks in the conveyance direction (S163). That is, the CPU 151 detects whether there is periodicity in the CD streaks, and if there is periodicity, at what cycles the CD streaks appear, and the variation (irregularity) of the CD streaks in each detected cycle. The periodicity is not limited to a single pattern, and there can be a mixture of periodic and non-periodic CD streaks. In addition, the cycle of the CD streaks may exhibit some variation.

Examples of locations that can cause periodic CD streaks include a drum unit, a developing unit, an intermediate transfer belt, a transfer roller, a fixing belt, and an upper fixing roller. The cycle at which the CD streaks occur varies depending on the location of the cause. Therefore, the location of the cause can be identified from the cycle of the detected CD streaks. These correspondences may be stored in advance as the feature information 153b in the nonvolatile memory 153 of the control block 15 and referred to by the CPU 151 as necessary. The cycle of the CD streaks is easily obtained using, for example, the Fourier transform or the like. On the other hand, when there is no periodicity in the CD streaks, it is difficult to identify the location of the cause from image diagnosis information. Therefore, in this case, it is only necessary to output, as a result, the occurrence of the CD streaks with no identified cause.

The CPU 151 sets the detailed rank of each detected non-periodic CD streak and the detailed rank for each cycle of the detected periodic CD streaks (S164). The CPU 151 determines whether the detailed ranks for all the cycles are within a reference range (S165). If the CPU 151 determines that all of the detailed ranks are within the reference range (S165; YES), the CPU 151 ends the CD streak detailed analysis process and returns the process to the detailed image diagnosis process.

If the CPU 151 determines that not all of the detailed ranks are within the reference range, that is, there is a detailed rank outside the reference range (S165; NO), the CPU 151 identifies the cause corresponding to the cycle of the detailed rank outside the reference range. The CPU 151 takes action for the identified cause or performs a notification operation using the display part 142 or the like to prompt the user or the like to take action (S166).

The CPU 151 determines whether the non-periodic streak is at an OK level (S167). If the CPU 151 determines that the non-periodic streak is not at the OK level (S167; NO), the CPU 151 determines that there is a non-periodic streak with no identified cause (S168). The CPU 151 ends the CD streak detailed analysis process and returns the process to the detailed image diagnosis process.

If the CPU 151 determines that the non-periodic streak is at the OK level (S167; YES), the CPU 151 ends the CD streak detailed analysis process and returns the process to the detailed image diagnosis process.

As described above, in one embodiment, the image adjustment including the streak and spot detection process is performed after the front and back adjustment, but the front and back adjustment can be canceled by user setting. Further, the feeding tray 12a for which the front and back adjustment is performed may be selectable.

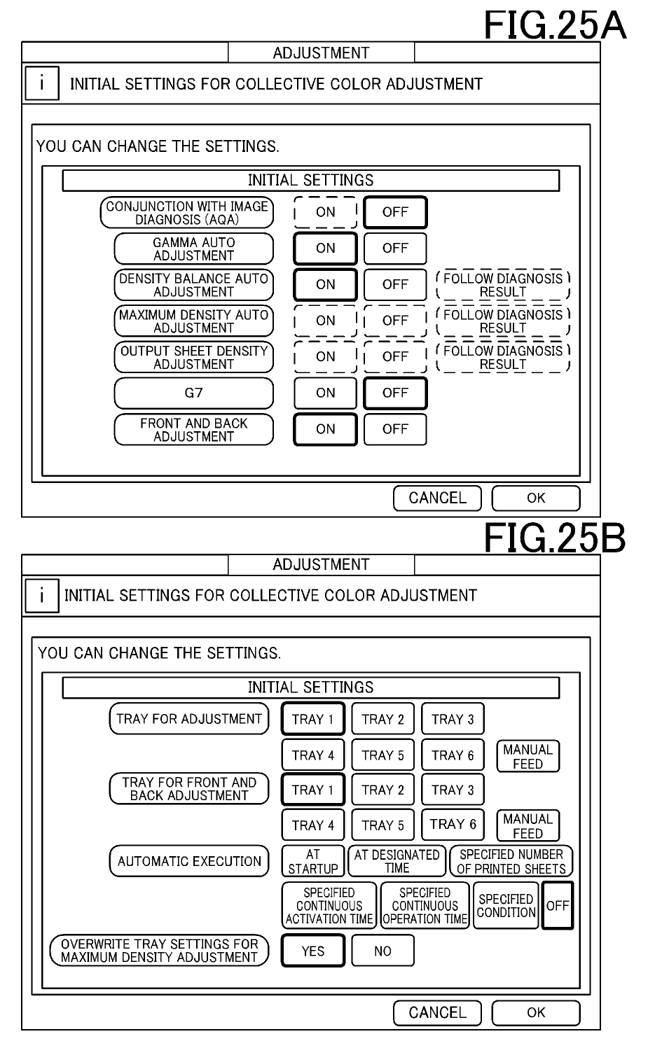

FIGS. 25A and 25B are diagrams illustrating examples of an initial setting screen for the image adjustment that is displayed on the display part 142 or the like.

Note that these initial setting screens may be output to the outside and remotely displayed on a display or the like of an external device.

As illustrated in FIG. 25A, on the initial setting screen, the user may be allowed to select whether to actually adjust each item that can be an adjustment target. For some of the adjustments, whether the adjustment is necessary may be automatically determined according to the results of the image diagnosis. Such adjustments may include selection of whether to perform the front and back adjustment. For example, when the image diagnosis is required many times a day, it is assumed that the results of the previous front and back adjustment are valid and re-execution of the front and back adjustment is omitted. That is, the frequency at which the front and back adjustment is required can be different from the frequency at which the image diagnosis and the image adjustment are required. Therefore, the display screen of the initial settings may include not only a simple selection of whether execution is necessary, but also, for example, a setting that makes re-execution within a specified period unnecessary.

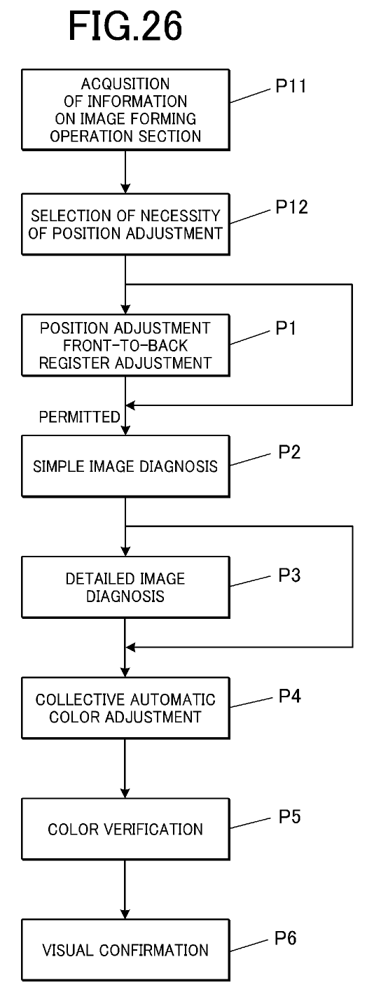

FIG. 26 is a diagram illustrating a procedure of image diagnosis according to another embodiment.

In this embodiment, steps P11 and P12 are added. Since steps P1 to P6 are the same as those described above, detailed descriptions thereof are omitted.

At any time or at suitable intervals, information on the state of the image forming operation section is acquired (P11; an acquisition step). When the acquired information satisfies the execution conditions of the subsequent steps, the process proceeds to step P12. The information on the state may include, for example, the number of images formed (printed) since the previous diagnosis, the continuous activation time since the activation of the image forming apparatus 1, i.e., since the start of power supply, and the continuous operation time during which images are continuously formed in the image forming apparatus 1, as illustrated in the above example. On the other hand, the continuous elapsed time since the execution of the last image forming operation (print job), i.e., the standby time can also be the information to be acquired. The information on the state may also be the temperature or humidity measured by the measurement section 17, the amount of change in temperature or humidity, or the like. Furthermore, interruption of the image forming operation due to replenishment of a specific feeding tray 12a with a medium or the like can also be a condition for executing the image diagnosis. For example, the replenishment of a medium may be identified by a weight increase of the feeding tray 12a with a weight sensor attached to the feeding tray 12a or determined when the remaining amount of the medium becomes no longer zero. Alternatively, more simply, the replenishment of a medium may be indirectly determined by a pulling operation or a retracting operation of the feeding tray 12a, or even by the opening and closing of a door for opening the feeding tray 12a.

In step P12, a process of selecting whether the position adjustment is necessary (P12; determination step) is executed. If the position adjustment is not necessary, the step of the position adjustment and the front-to-back register adjustment (P1) is omitted, and the simple image diagnosis (P2) is started.

As described above, the omission of the position adjustment may be possible only when a predetermined condition is satisfied. Alternatively, whether to perform the position adjustment may be simply determined according to a request from the user. The user's request may be received by the operation reception section 141. On the other hand, even in the case where there is a request to omit the position adjustment from the user, the omission of the position adjustment may not be permitted when necessary position adjustment has not been performed. In other words, the execution of the simple image diagnosis (P2) and the subsequent steps may be permitted only for the feeding tray 12a whose position has been adjusted. In this case, the CPU 151 may cause the display part 142 to notify that necessary position adjustment is to be performed. When the CPU 151 repeatedly receives a request to omit the position adjustment despite the notification operation, step P1 may be omitted and the execution of step P2 and the subsequent steps may be permitted.

As illustrated in FIG. 25B, the user may be allowed to select a feeding tray 12a (first feeding tray) that stores a medium for which the position adjustment is performed and a feeding tray 12a (second feeding tray) that stores a medium for which the image diagnosis and image quality adjustment are performed. The first feeding tray and the second feeding tray may be selected from a part or all of the plurality of feeding trays 12a. In this case, the second feeding tray may be selectable only from the first feeding tray. Furthermore, the second feeding tray may be selectable from one of the first feeding trays. That is, the second medium may be supplied from one of the first feeding trays. Based on an input operation to the touch screen 141a and the contents of the initial setting screen displayed on the display screen 142a at the time of the input operation, the CPU 151 receives the selection settings.

As described above, the position adjustment, the image diagnosis, and the like may be automatically activated at a specific timing. This specific timing may be selected by the user. The specific timing may be, for example, at the activation of the image forming apparatus 1 or at a designated time. Furthermore, even at the designated time, an interval of a predetermined number of days, for example, three days, may be provided after the position adjustment or image diagnosis is performed most recently. Furthermore, the position adjustment and the image diagnosis may be selectively set so as not to be performed at a specific timing. In this case, the user instructs the execution of position adjustment or image diagnosis by an input operation or the like at a necessary timing. For example, at the time of job output, the user may be allowed to set whether to perform the image diagnosis via the operation reception section 141. Furthermore, the reference time for the continuous activation time (third reference time), the reference time for the continuous operation time (second reference time), the reference time for the elapsed time (first reference time), and the like may be defined by the user, as described above. Similarly, specified conditions may be predetermined by the user, such as a predetermined number serving as a reference for the number of sheets for image formation, reference values for temperature, humidity, and the like, a variation in the operations of the conveyance sections 13 and 23, and an offset reference value. The user may be allowed to set the reference times, the predetermined number, the reference values, and the like suitably or within a predetermined range of values.

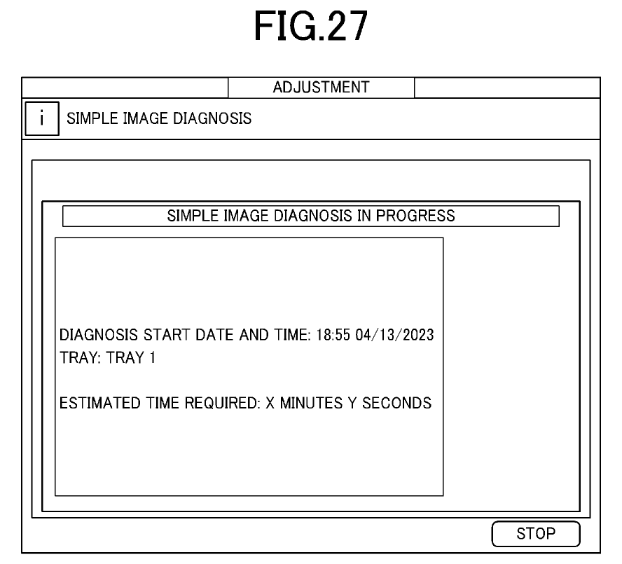

FIG. 27 is a diagram illustrating an example of a screen displayed while the image diagnosis is in progress.

While the image diagnosis is in progress, the CPU 151 may cause the display screen 142a to display and output an expected time required for the execution of the image diagnosis. As a result, the user does not need to monitor the image forming apparatus 1 until the image diagnosis is completed, and the waiting time during which the user does not check the results after the image diagnosis is completed can easily be reduced.

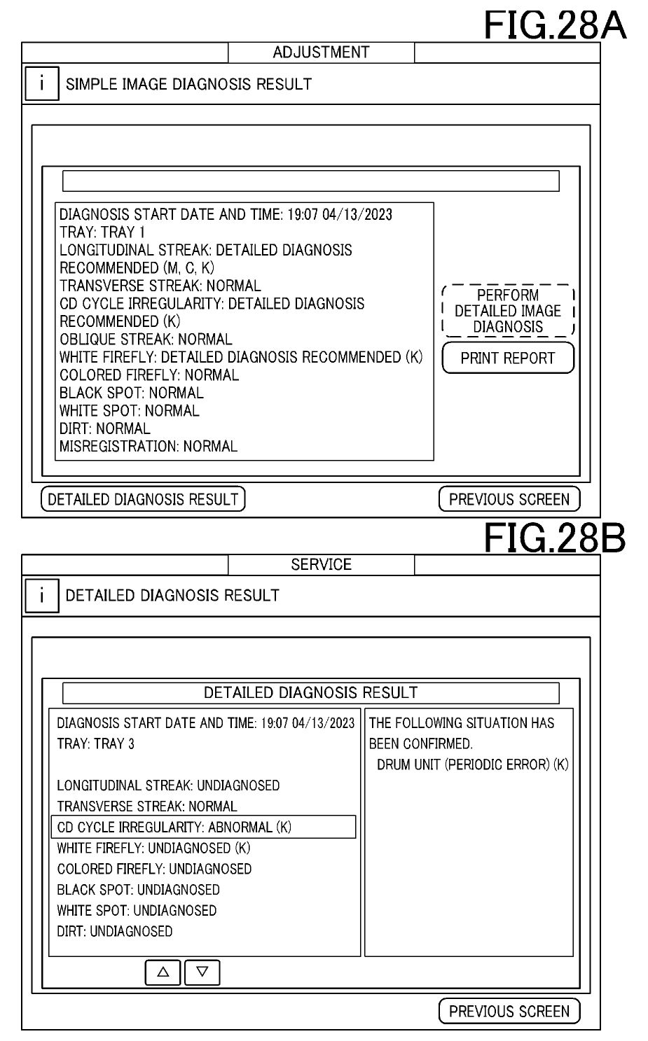

FIG. 28A and FIG. 28B are diagrams illustrating examples of a result display screen displayed after the execution of the image diagnosis.

As illustrated in FIG. 28A, after the simple image diagnosis process is completed, the results of the simple image diagnosis process may be displayed on the display screen of the display part 142. The displayed output content of the results of the simple image diagnosis process may include the detection results of the misregistration state of the image formation position based on the first test image or the second chart above.

A button for requesting the execution of detailed image diagnosis may be displayed on the screen displaying the results of the simple image diagnosis. That is, the detailed image diagnosis may not be automatically executed but executed after receiving a request from the user. Alternatively, the simple image diagnosis and the detailed image diagnosis may be executed in succession, and the results of the simple image diagnosis may be first displayed after the detailed image diagnosis. In this case, as a display target of the detailed image diagnosis result, an item for which the detailed diagnosis has been executed may be selectable from the simple image diagnosis result. Alternatively, the detailed diagnosis result may be displayed in the form of a list similarly to the display of the simple image diagnosis result, and the results for the selected item may be displayed in more detail.

In FIG. 28B, as the detailed diagnosis result, a list is displayed on the left side of the display screen, and detailed results of irregularity in the CD cycle selected from the list are shown on the right side of the display screen.

As described above, the image diagnostic method according to the present embodiment is a method executed by the image diagnostic device for an image formed by the image forming apparatus 1 including the image forming operation section 11 and the reading device 20. The reading device 20 is disposed along the conveyance paths 130 and 230 of the medium and reads the medium downstream of the image formation site of the image forming operation section 11 on the conveyance paths 130 and 230. In this image diagnostic method, the image diagnostic device executes the adjustment step and the diagnosis step to be executed after the adjustment step. The adjustment step includes the following processes. (1) The first test image I1 for adjusting the image formation position is formed by the image forming operation section 11. (2) The first medium on which the first test image I1 has been formed is read by the reading device 20. (3) The image formation position is adjusted based on the reading result of the first medium. The diagnosis step includes the following processes. (1) The second test image for diagnosing the state of the image forming operation section 11 is formed by the image forming operation section 11. (2) The second medium on which the second test image has been formed is read by the reading device 20. (3) The diagnosis result of the state of the image forming operation section 11 is acquired based on the reading result of the second medium. According to the image diagnostic method, since the position adjustment of the image formation position is performed before the image formation for image diagnosis, the test image for image diagnosis is formed with higher accuracy. Therefore, the accuracy of image diagnosis is improved as compared with the related art. As a result, the efficiency of adjustment is improved, and repetition of diagnosis and adjustment due to inability to obtain a proper image is reduced.

In addition, the front-to-back register adjustment of the medium may be performed in the adjustment step. Not only the image formation position on each surface but also the image formation positions on the front and back surfaces can be more appropriately aligned.

Furthermore, the image diagnostic method according to the present embodiment may further include an acquisition step of acquiring, by the image diagnostic device, information on the state of the image formation position, and a determination step of determining, based on the acquired state, whether to execute the adjustment step before the diagnosis step. Basically, the position adjustment and the image diagnosis are performed as a set, but it may be possible to omit the position adjustment in the image diagnostic device. For example, when the image diagnosis is frequently performed, the position adjustment may not necessarily be performed every time. As a result, it is possible to reduce the time required for the image adjustment and the amount of medium and toner used for the position adjustment.

Further, the image forming apparatus 1 may include the feeding tray 12a that stores the medium. In the acquisition step, information on replenishment of the feeding tray 12a with the medium may be acquired as the state. The adjustment step may be executed when the replenishment of the feeding tray 12a with the medium has been performed after the most recent adjustment step and/or when the replenishment of the feeding tray 12a with the medium has been performed after the most recent image forming operation. As a result, it is possible to reduce the possibility of excessive consecutive position adjustments in a situation where the image formation position is not changed.

Further, in the acquisition step, information on the elapsed time since the execution of the previous image forming operation may be acquired as the state. In the determination step, it may be determined that when the elapsed time is equal to or greater than the first reference time, the adjustment step is to be executed. The change in the image formation position depends on the elapse of time to some extent. Therefore, it is possible to efficiently maintain the accuracy of image diagnosis by executing the adjustment step at intervals equal to or greater than an appropriate reference time.

Further, in the acquisition step, information on at least one of temperature or humidity relating to the image forming apparatus 1 may be acquired as the state. The temperature and humidity affect the state of the medium and the fixing state of the toner. Therefore, by including the temperature and humidity in the image formation parameters, the image quality can be stabilized. Further, in this case, by suitably checking and adjusting the image formation position, it is possible to reduce the effects of expansion and contraction, distortion, and the like of the medium, thereby performing image diagnosis with higher accuracy.

In addition, the image forming apparatus 1 may include one or more feeding trays 12a that store the media. The first medium may be supplied from the first feeding tray among the feeding trays 12a. That is, since the first feeding tray for supplying the medium for the alignment and image diagnosis is determined in advance, the image diagnosis can be performed with the same quality. On the other hand, when there is a plurality of feeding trays 12a, it is possible to quickly shift to the normal image formation after the image diagnosis. Therefore, according to the image diagnostic method, it is possible to more efficiently adjust the image quality and output a high-quality image to a desired medium.

Further, the image forming apparatus 1 may include a plurality of feeding trays 12a having a plurality of first feeding trays. The adjustment step may be executed on each of the first media supplied from the plurality of first feeding trays. By including the plurality of feeding trays 12a, the image forming apparatus 1 can quickly switch and supply the medium according to the intended use to form an image. In addition, since the image forming apparatus 1 includes the plurality of feeding trays 12a, it is possible to easily switch between multiple sizes of image formation. The plurality of first feeding trays also allows for flexibility in the allocation of the plurality of feeding trays 12a. Furthermore, when the medium usable for the image diagnosis is stored in the plurality of feeding trays 12a, the plurality of first feeding trays can be easily switched and used according to the storage state of the medium.

Furthermore, in the image diagnostic method according to the present embodiment, a setting for selecting the first feeding tray may be received. That is, since the medium for the position adjustment and the image diagnosis can be stored in the feeding tray that the user desires, the user can suitably allocate the feeding tray.

In addition, the second medium may be supplied from a part or all of the first feeding trays. That is, the diagnosis and adjustment of the image quality may be performed with the same medium as the position adjustment of the formed image. Since the adjustment is performed with the medium having the same sheet condition, it is possible to perform the adjustment with higher stability and accuracy. Furthermore, in this case, different media in the first feeding trays may be used according to the contents of the image diagnosis and the image quality adjustment. As a result, the efficiency of the adjustment can be further improved.

The second medium may be supplied from one of the first feeding trays. That is, the image diagnosis and the image quality adjustment may be performed using any one of the media for which the position adjustment of the image has been performed. As long as the position adjustment has been performed, the adjustment with sufficiently high accuracy can be performed with the medium supplied from one of the first feeding trays. Therefore, it is possible to perform the adjustment with the minimum amount of media required.

Further, the image diagnostic device may permit the execution of the diagnosis step for the feeding tray 12a for which the adjustment step has been executed. In other words, the execution of the diagnosis step using the medium supplied from the feeding tray 12a for which the adjustment step has not been executed may be prohibited. As a result, it is possible to prevent inaccurate adjustments from being performed by mistake, preventing a decline in work efficiency and reducing wasted media.

Furthermore, the image diagnostic method according to the present embodiment may be capable of

receiving a setting for selecting the first feeding tray for which the diagnosis step is to be executed. Therefore, the user can select an optimal medium to diagnose and adjust the image quality. As a result, it is possible to flexibly use each feeding tray 12a to store a necessary medium.

In addition, a diagnosis result may be output in the diagnosis step. The output content of the diagnosis result may include a diagnosis result of the image formation position. Since the diagnosis result is presented to the user, the user can easily know the problem that has occurred. In addition, since the diagnosis result includes the misregistration information of the image formation position, the user can easily recognize the occurrence of misregistration as a problem in the same manner as the results of other image diagnosis.

In addition, when the diagnosis step is executed after the execution of the adjustment step, the second pattern may include a pattern for identifying the image formation position on the second medium. In the diagnosis step, it may be diagnosed whether the image formation position is correctly adjusted. Basically, the misregistration is correctly adjusted based on the first pattern. However, by confirming whether the misregistration is correctly adjusted in conjunction with the image diagnosis, it is possible to efficiently proceed with highly accurate adjustment.

In the image diagnostic method according to the present embodiment, the process including the adjustment step and the diagnosis step may be executed in at least one of the following cases. (1) A case where the image forming operation section 11 is activated. (2) A case where it is a designated time. (3) A case where the image forming operation section 11 has formed images on a predetermined number or more of media. (4) A case where the image forming operation section 11 has operated for the second reference time or more. (5) A case where power is supplied to the image forming operation section 11 for the third reference time or more. (6) A case where a predetermined change is detected in the conveyance section that conveys the medium. Thus, the image diagnosis can be appropriately performed at suitable intervals or under conditions where a misregistration or a deviation in image quality can occur, thereby efficiently reducing a decrease in image accuracy.

Further, in the image diagnostic method according to the present embodiment, a setting input as to whether to execute the adjustment step may be received before the execution of the diagnosis step. As described above, it is basically preferable that the image formation position is adjusted before the diagnosis step. However, if not necessary, the adjustment step may be allowed to be omitted in response to a setting operation or the like by the user. As a result, unnecessary inspection time and consumption of the medium and the toner can be reduced.

In addition, in at least one of the adjustment step or the diagnosis step, an expected time required for execution may be output. Since it takes some time for the adjustment and the diagnosis, it is a waste of time for the user or the like to constantly monitor the image forming apparatus. On the other hand, if the user who leaves his/her seat during the adjustment or diagnosis does not return even after the results are obtained, the image forming operation cannot be restarted, resulting in a decrease in work efficiency. Therefore, by outputting the required time in advance, such as at the start of the step, it is possible for the user to effectively use time by performing other work or taking a break for an appropriate time without waste.

In addition, the image diagnostic device according to the present embodiment includes the CPU 151 capable of executing the above-described image diagnostic method. According to this image diagnostic device, it is possible to perform image adjustment with higher accuracy and enable the image forming apparatus 1 to efficiently form a suitable image.

Furthermore, the image forming apparatus 1 according to the present embodiment includes the above-described image diagnostic device. As a result, the image forming apparatus 1 can efficiently output an image adjusted with high accuracy.

Further, the program 153a according to the present embodiment causes the image diagnostic device to execute the above-described image diagnostic method. Therefore, it is possible to easily perform efficient and highly accurate image adjustment.

Note that the present disclosure is not limited to the above embodiments, and various modifications are possible.

For example, the controller that operates as the image diagnostic device may not be the CPU 151, the controller 100, or the reading controller 200 in the image forming apparatus 1. A controller (hardware processor) of the external device 50 may acquire data read or measured by the image forming apparatus 1 to perform the image diagnosis. Alternatively, the CPU 151 or the like of the image forming apparatus 1 as the image diagnostic device may outsource some of the processes to an external CPU, a dedicated processor, or the like, to acquire the results and perform the remaining processes.

Further, the image forming apparatus may be capable of forming an image on only one surface. In this case, the alignment and image diagnosis on the back surface are unnecessary. Further, even in a case where image formation can be performed on both surfaces, when an image is formed only on one surface, the image diagnosis or the like on the back surface may be omitted.

Furthermore, the image formation positions on the front and back surfaces may be adjusted independently of each other, and the alignment of the front and back surfaces may not be performed directly.

Furthermore, the pattern of the first test image I1 may not be the four straight lines having lengths close to the width and the length of the medium. For example, the first test image I1 may be a local cross, that is, a register mark or have any other shape that allows the amount of misregistration of the image formation position to be identified. The content and order of formation of the second test image I2 are not limited to those described above and may be determined as appropriate to the extent that the necessary information can be obtained.

Further, in the above description, the output destination for the image diagnosis setting and the diagnosis result is a display mechanism such as the display screen 142a but is not limited thereto. Audio output or the like may be used. Alternatively, the diagnosis result or the like may be outputtable as data in a document format such as PDF.

The feeding tray 12a for media may be a single tray. In this case, the single feeding tray 12a is fixed as the target of the position adjustment and the image diagnosis.

The reading of a document by the scanner 19 may be performed by placing the document on a platen glass (not illustrated). In addition, in the scanner 19, the printed material output from the image forming apparatus 1 may be conveyed or may be set manually for reading. That is, the scanner 19 may function as a reading section instead of or in addition to the reading device 20.

In addition, the reading device 20 may be a separate component from the image forming apparatus 1 without being mechanically connected in-line to the apparatus body 10. The reading device 20 may be configured to read a medium set by the user or the like. The reading result may be transmitted to the CPU 151 or the controller 100 via a communication line or a network. Alternatively, the reading result may be transmitted from the reading device 20 to the CPU 151 or the controller 100 via a detachable portable recording medium such as a memory stick. Furthermore, in the above-described embodiment, the image reading sections 24 and 25 are disposed in the reading device 20, but the present invention is not limited thereto. For example, the image reading sections 24 and 25 may be disposed in the apparatus body 10.

The image forming operation section 11 may not form a color image using the four colors of CMYK. An image may be formed in a greater number of colors, including other colors. Alternatively, the image forming operation section 11 may perform image formation in a single color such as monochrome.

In addition, a particular tray among the feeding trays 12a may be fixedly allocated for the image adjustment. Further, the conveyance paths 130 and 230 may not be reversible.

In addition, in the above description, the nonvolatile memory 153 such as an HDD, an SSD, or a flash memory has been described as an example of a computer-readable medium that stores the program 153a related to the control of the position adjustment and the image diagnosis of the present disclosure, but the present invention is not limited thereto. As other computer-readable media, other nonvolatile memories such as an MRAM and portable recording media such as a CD-ROM and a DVD disk can be applied. Furthermore, a carrier wave is also applied to the present disclosure as a medium for providing data of the program according to the present disclosure via a communication line.

In addition, the specific configurations, the contents and sequence of the processing operations, and the like described in the above embodiment can be appropriately changed without departing from the spirit and scope of the present invention. The scope of the present disclosure includes the scope of the invention described in the claims and the equivalent scope thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image diagnostic method executed by an image diagnostic device for an image formed by an image forming apparatus including:
an image forming engine; and
a reader that is disposed along a conveyance path of a medium and reads the medium downstream of an image formation site of the image forming engine on the conveyance path,
the image diagnostic method comprising:
adjusting an image formation position; and,
after the adjusting has been executed, diagnosing a state of the image forming engine, wherein
the adjusting includes:
causing the image forming engine to form a first pattern for adjusting the image formation position;
causing the reader to read a first medium on which the first pattern has been formed; and
adjusting the image formation position based on a reading result of the first medium, and
the diagnosing includes:
causing the image forming engine to form a second pattern for diagnosing the state of the image forming engine;
causing the reader to read a second medium on which the second pattern has been formed; and
acquiring a diagnosis result of the state of the image forming engine based on a reading result of the second medium.

2. The image diagnostic method according to claim 1, wherein the adjusting includes front-to-back register adjustment of the medium.

3. The image diagnostic method according to claim 1, further comprising, by the image diagnostic device:
acquiring information on a state of the image formation position; and
determining, based on the acquired information on the state, whether to execute the adjusting before the diagnosing.

4. The image diagnostic method according to claim 3, wherein
the image forming apparatus includes a feeding tray that stores the medium,
the acquiring includes acquiring, as the state, information on replenishment of the feeding tray with the medium, and
the adjusting is to be executed when the replenishment of the feeding tray with the medium is performed after the adjusting has been executed most recently and/or when the replenishment of the feeding tray with the medium is performed after a most recent image forming operation.

5. The image diagnostic method according to claim 3, wherein
the acquiring includes acquiring, as the state, information on an elapsed time since execution of a previous image forming operation, and
when the elapsed time is equal to or greater than a first reference time, the determining includes determining that the adjusting is to be executed.

6. The image diagnostic method according to claim 3, wherein the acquiring includes acquiring, as the state, information on at least one of temperature or humidity relating to the image forming apparatus.

7. The image diagnostic method according to claim 1, wherein
the image forming apparatus includes one or more feeding trays that store the medium, and
the first medium is supplied from a first feeding tray among the one or more feeding trays.

8. The image diagnostic method according to claim 7, wherein
the one or more feeding trays include a plurality of feeding trays,
the first feeding tray includes a plurality of first feeding trays, and
the adjusting is executed for the first medium supplied from each of the plurality of first feeding trays.

9. The image diagnostic method according to claim 7, further comprising receiving a setting for selecting the first feeding tray.

10. The image diagnostic method according to claim 7, wherein the second medium is supplied from a part or all of the first feeding tray.

11. The image diagnostic method according to claim 8, wherein the second medium is supplied from one of the plurality of first feeding trays.

12. The image diagnostic method according to claim 1, wherein
the image forming apparatus includes a feeding tray that stores the medium, and
the image diagnostic device permits execution of the diagnosing for the feeding tray for which the adjusting has been executed.

13. The image diagnostic method according to claim 10, further comprising receiving a setting for selecting the first feeding tray for which the diagnosing is to be executed.

14. The image diagnostic method according to claim 1, wherein
the diagnosing includes outputting the diagnosis result, and
output content of the diagnosis result includes a diagnosis result of the image formation position.

15. The image diagnostic method according to claim 14, wherein when the diagnosing is executed after the adjusting has been executed,
the second pattern includes a pattern for identifying the image formation position on the second medium, and
the diagnosing includes diagnosing whether the image formation position is correctly adjusted.

16. The image diagnostic method according to claim 1, wherein an process that includes the adjusting and the diagnosing is executed in at least one of:
a case where the image forming engine is activated;
a case where it is a designated time;
a case where the image forming engine has formed an image on a predetermined number or more of the medium;
a case where the image forming engine has operated for a second reference time or more;
a case where power is supplied to the image forming engine for a third reference time or more; or
a case where a predetermined change is detected in a conveyance section that conveys the medium.

17. The image diagnostic method according to claim 1, further comprising: before the diagnosing is executed, receiving a setting input as to whether to execute the adjusting.

18. The image diagnostic method according to claim 1, wherein in at least one of the adjusting or the diagnosing, an expected time required for execution is output.

19. An image diagnostic device comprising a hardware processor capable of executing the image diagnostic method according to claim 1.

20. An image forming apparatus comprising the image diagnostic device according to claim 19.
